(19) United States
(12) Patent Application Publication
(10) Pub. No.: US 2024/0245255 A1
(43) Pub. Date: Jul. 25, 2024

(54) COFFEE MACHINE AND MILK TEXTURING DEVICE

(71) Applicant: BREVILLE PTY LIMITED, Alexandria, New South Wales (AU)

(72) Inventors: Richard HARROD, Alexandria, New South Wales (AU); Alexander Robert PROFILIO, Alexandria, New South Wales (AU); Christopher Peter Hamilton HARDY, Alexandria, New South Wales (AU); Adam Samuel HILLIARD, Alexandria, New South Wales (AU)

(21) Appl. No.: 18/563,501

(22) PCT Filed: May 26, 2022
(86) PCT No.: PCT/AU2022/050507

§ 371 Date: Nov. 22, 2023

(30) Foreign Application Priority Data
May 26, 2021 (AU) 2021901581
Nov. 17, 2021 (AU) 2021903700

(51) Int. Cl. A47J 31/44

(52) U.S. Cl. CPC A47J 31/4428; A47J 31/4482; A47J 31/4489

(57) ABSTRACT

A coffee machine comprising: a coffee extraction module with a dispensing spout and a supporting body; a platform for detachable connection with the supporting body at a plurality of different spacings beneath the dispensing spout; and a drip tray assembly positionable beneath the dispensing spout, the drip tray assembly having a support surface, wherein the support surface of the drip tray assembly is configured to receive the platform such that the support surface and the platform are substantially co-planar, and wherein the platform and the drip tray assembly are configured to engage and disengage from the supporting body via horizontal relative movement.

### FIELD

The present invention relates to coffee machines and in particular coffee machines that dispense coffee.

The present invention also relates to devices for texturing milk by the injection of steam. In particular, the invention provides a milk texturing device that promotes correct positioning of a milk jug relative to the steam wand used for the steam injection.

### BACKGROUND

Coffee machines for extracting a dose of espresso coffee from ground coffee are widely used in commercial and domestic settings. Likewise, there are steam modules widely available for frothing or “texturing” milk for various milk-based coffee beverages. The steam modules may be integrated into the coffee machine or a separate device.

The optimum parameters for extracting coffee from a particular type or grind of coffee bean is usually known to the coffee manufacturers and much of the extraction process is automated for better results. This particularly applies to so-called coffee pod or coffee capsule machines that extract a dose of espresso from a pre-packaged, sealed capsule of coffee that is inserted into the machine. The operation of the coffee machine is configured to match the selected capsule of ground coffee.

Capsule machines are popular for domestic use given the high level of automation. However, in a domestic setting, the overall size of the machine is important because bench space and shelf space is often limited. This makes integrating a steam module into a capsule machine more complicated in light of the need to maintain a compact design. The heat generated by a steam module operating immediately next to the coffee extraction module can alter some of the predefined extraction parameters which may be detrimental to the extracted coffee dose. A separate steam module (with its own power cord) may be less convenient for the user.

A coffee machine for domestic use should be compact in terms of its “footprint” on the benchtop, but also in terms of height. Many appliances are stored in cupboards when not in use and are stored under cupboards when in use. The shelf height in cupboards can often be fixed and if the shelves are adjustable, raising the height of one shelf to store a tall appliance will reduce the storage available on the shelf above. Also, it is undesirable if the height of appliances is too high to be stored or used under cupboards.

Domestic users also favour coffee machines that minimise any mess and spillage. Drip trays are typically used to collect any spilled liquids but eventually these need to be drained and cleaned. Manually moving the tray to the sink has a risk of spilling liquids on the bench and/or floor. This is particularly so if the drip tray has been allowed to fill to its full capacity before being emptied in the sink. Also, the spillage issues may be more serious if the height of drip tray is reduced to accommodate the above-mentioned height requirements.

Turning to milk texturing, which is commonly referred to as “milk frothing”, this process typically involves injecting steam into the milk to create a foam layer on top. The steam also heats the milk to a temperature suitable for various milk-based coffee beverages such as lattes, flat whites and cappuccinos.

Milk texturing (frothing) can be inconsistent. The milk frother will commonly have a steam wand that is inserted into a jug partially filled with milk. Steam is injected into the milk and this ‘aeration’ froths the milk. However, the texturing process can have inconsistent results depending on the position of the steam wand in the jug. Positioning the end of the wand close to the internal side or bottom of the jug can result in discernible differences from milk textured with the steam wand more centrally positioned within the milk in the jug.

To assist users with the correct vertical spacing between the steam wand and the bottom of the milk jug, milk frothing devices may have a support surface at the optimal height beneath the steam wand for a “standard” or known milk jug. The support surface may include a shallow recess in which the milk jug is placed for the optimal spacing between the end of the wand and the bottom of the jug. However, the user may not take at the time to ensure the jug is correctly or fully placed in the recess, particularly as a slightly misplaced jug will still allow frothing of the milk, albeit with less than optimal results.

More sophisticated milk texturing devices incorporate a temperature sensor to indicate when the milk has been heated to the correct temperature range. If the temperature sensor is positioned in the jug support surface, contact with the jug can be compromised which can result in insufficient or excessive heating of the milk. Similarly, incorrect positioning of the steam wand tip within the milk jug can also result in poorly textured milk because of over aeration, under aeration or large milk bubble foam. These factors affect the taste of the milk and ultimately the flavour of the milk-based coffee.

Milk frothing devices are known from the following publications: Labrints BVBA Publication WO 2021/037918 A2, Coffee Innovations Pty Limited, Marzocco Srl Publication US 2020/0138233 A1, and William Westmore Purton U.S. Pat. No. 10,271,697 B2.

Throughout the specification, the term ‘milk’ will be understood as including dairy milk and non-dairy milk such as soy milk, hazelnut milk, coconut milk, goats' milk or other ‘milks’ that may be textured by steam to prepare a hot beverage.

### SUMMARY

There is disclosed herein a coffee machine comprising:
a coffee extraction module with a dispensing spout and a supporting body;
a platform for detachable connection with the supporting body at a plurality of different spacings beneath the dispensing spout; and
a drip tray assembly positionable beneath the dispensing spout, the drip tray assembly having a support surface,
wherein the support surface of the drip tray assembly is configured to receive the platform such that the support surface and the platform are substantially co-planar, and
wherein the platform and the drip tray assembly are configured to engage and disengage from the supporting body via horizontal relative movement.

The support surface of the drip tray assembly may be adapted to receive a receptacle, the support surface having apertures and a reservoir for collecting liquid draining through the apertures.

The platform may be adapted to support the receptacle beneath the dispensing spout.

The platform may be a movable cup support configured to detachably engage the drip tray assembly.

The supporting body of the coffee extraction module may have a series of connection points for detachable inter-engagement with the cup support to provide the plurality of different spacings beneath the spout.

The connection points may be sockets in the supporting body, wherein the cup support has a protrusion shaped for insertion in any of the sockets such that the platform is substantially horizontal.

The sockets may include a lower socket disposed adjacent a lower surface of the supporting body, and wherein the protrusion of the cup support is horizontally slidable into the lower socket.

The coffee machine may further include a steam module for frothing milk, wherein the steam module has a steam wand and the drip tray assembly is positionable beneath the coffee dispensing spout and the steam wand.

The drip tray assembly may have a coffee drip tray and a steam drip tray, and wherein the coffee drip tray and the steam drip tray are integrally formed.

The coffee drip tray may alternatively be separately formed from the steam drip tray and movable relative to the steam drip tray.

The coffee drip tray may have a coffee drip reservoir and the steam drip tray may have a milk drip reservoir that is not fluidically connected to the coffee drip reservoir.

The coffee drip tray may be detachably engageable with the platform such that the coffee drip tray and the platform are both positionable at the plurality of different spacings beneath the spout.

There is further disclosed herein a coffee machine comprising:
a coffee extraction module with a dispensing spout and a supporting body;
a cup support for detachable connection with the supporting body at a plurality of different spacings beneath the spout; and
a steam module for frothing milk.

There is further disclosed herein a coffee machine comprising:
a coffee extraction module with a dispensing spout and a supporting body;
a platform for supporting a cup beneath the spout; wherein during use,
the supporting body and the platform are configured to engage and disengage via horizontal relative movement.

Preferably, the platform is provided by a drip tray assembly such that horizontal movement of the drip tray assembly relative to the supporting body allows engagement and disengagement with the supporting body.

Preferably, the coffee machine further comprises a drip tray assembly wherein the platform is a movable cup support configured to detachably engage the drip tray assembly.

There is further disclosed herein a coffee machine comprising:
a coffee extraction module with a dispensing spout and a supporting body;
a platform for detachable connection to the supporting body, the supporting body being configured to detachably connect to the platform at a plurality of different spacings beneath the spout; and,
a drip tray assembly having a support surface for supporting a receptacle, the support surface having apertures and a reservoir for collecting liquid draining through the apertures.

Preferably, the coffee machine further comprises a drip tray assembly wherein the steam module has a steam wand and the drip tray assembly is positionable beneath the coffee dispensing spout and the steam wand.

Preferably, the drip tray assembly has a support surface for supporting a receptacle, the support surface having apertures and a reservoir for collecting liquid draining through the apertures.

Preferably, the cup support has a platform for supporting the cup beneath the dispensing spout, and the support surface of the drip tray is configured to receive the platform such that the support surface and the platform are substantially co-planar.

Preferably, the supporting body has a series of connection points for detachable inter-engagement with the cup support to provide the plurality of different spacings within the spout.

Preferably, the connection points are sockets in the supporting body, wherein the cup support has a protrusion shaped for insertion in any of the sockets such that the platform is substantially horizontal.

Preferably, the drip tray assembly has a coffee drip tray and a steam drip tray, the coffee drip tray being movable relative to the steam drip tray and the coffee drip tray having a coffee drip reservoir and the steam drip tray having a milk drip reservoir that is not fluidically connected to the coffee drip reservoir.

Preferably, the coffee drip tray is detachably engageable with the cup support such that the coffee drip tray and the cup support are both positionable at the plurality of different spacings beneath the spout.

There is further disclosed herein a drip tray assembly for use with a coffee machine, the drip tray assembly comprising a support surface for supporting a receptacle, the support surface having a plurality of apertures;
a reservoir for collecting liquid draining through the apertures; and,
a baffle structure for defining a plurality of reservoir sections in which the liquid collects and at least partially obstructing the flow of the liquid from one of the sections to another.

Preferably, the baffle structure has a series of spaced baffles, and the reservoir is a tray with a floor extending generally horizontally and at least one side wall extending upwards from the floor, the spaced baffles providing walls within the tray to at least partially obstruct liquid flow towards the side wall in response to inertia of the liquid when the drip tray is moved.

Preferably, the spaced baffles extend downwards from an underside of a mounting plate positionable beneath the support surface, the mounting plate having apertures allowing the liquid to drain to the floor of the tray.

Preferably, the drip tray assembly further comprises a liquid level indicator to provide a visual indication of a current level of the liquid in the reservoir.

Preferably, the liquid vessel indicator has a float section, a pivot connection for rotation of the float section through an arc, and a visual indicator connected to the float section for movement therewith, such that, the float section travels through the arc in response to the liquid filling the reservoir thereby moving the visual indicator within a user field of view.

Preferably, the pivot connection is on the baffle structure.

Preferably, the visual indicator is spaced further from the pivot connection that the sloped section such that the visual indicator moves a greater distance than the float section in response to the liquid filling the reservoir.

There is further disclosed herein a drip tray assembly for use with a coffee machine, the drip tray assembly comprising a support surface for supporting a receptacle, the support surface having a plurality of apertures;
a reservoir for collecting liquid draining through the apertures; and,
a liquid level indicator to provide a visual indication of a current level of the liquid in the reservoir, the liquid vessel indicator having a float section, a pivot connection for rotation of the float section through an arc, and a visual indicator connected to the float section for movement therewith, such that, the float section travels through the arc in response to the liquid filling the reservoir thereby moving the visual indicator within a user field of view.

Preferably, the drip tray assembly further comprises a baffle structure for defining a plurality of reservoir sections in which the liquid collects and at least partially obstructing the flow of the liquid from one of the sections to another.

Preferably, the pivot connection is on the baffle structure.

Preferably, the visual indicator is spaced further from the pivot connection that the sloped section such that the visual indicator moves a greater distance than the float section in response to the liquid filling the reservoir.

Preferably, the baffle structure has a series of spaced baffles, and the reservoir is a tray with a floor extending generally horizontally and at least one side wall extending upwards from the floor, the spaced baffles providing walls within the tray to at least partially obstruct liquid flow towards the side wall in response to tilting the floor away from horizontal.

Preferably, the spaced baffles extend downwards from an underside of a mounting plate positionable beneath the support surface, the mounting plate having apertures allowing the liquid to drain to the floor of the tray.

There is further disclosed herein a coffee machine comprising:
a coffee extraction module with a coffee dispensing spout and a supporting body;
a steam module for frothing milk; and
a storage cavity for storing a power cord to power the machine, the storage cavity being positioned between the coffee extraction module and the steam module; wherein,
the storage cavity has a vertical dimension that substantially exceeds the horizontal dimension extending in a direction of lateral spacing between the extraction module and the steam module.

Preferably, the coffee machine further includes a cord channel disposed below a water tank of the coffee machine, the cord channel being adapted to accommodate the power cord extending between the storage cavity and an exterior of the coffee machine.

Preferably, the storage cavity includes one or more tracks to guide movement of the power cord between a retracted configuration and an extended configuration.

Preferably, the storage cavity includes one or more guide portions located in path of the power cord within the storage cavity, the one or more guide portions being adapted to protect the power cord from being damaged by other components within the storage cavity.

There is further disclosed herein a milk texturing device comprising:
a steam wand for fluidic connection with a source of steam;
a support surface with an array of drainage apertures; and
a receptacle support positioned within the support surface for supporting a milk receptacle in a predetermined position relative to the steam wand; wherein
the receptacle support has a raised portion above the support surface to guide user placement of the milk receptacle into the predetermined position.

Preferably, the receptacle support provides a platform raised above the support surface.

Preferably, the receptacle support has a recessed portion lower than the raised portion, the recesses portion being configured to support the milk receptacle with the raised portion positioned at the periphery of the recessed portion.

Preferably, the recessed portion is lower than the support surface.

Preferably, a milk texturing device further comprises a temperature sensor configured to generate an output indicative of the temperature of milk being textured in the milk receptacle. Preferably, the temperature sensor is positioned in the receptacle support for contact with the milk receptacle.

Preferably, the receptacle support is positioned in the support surface to guide user placement of the milk receptacle such that the steam wand maintains a first spacing to an internal side of the milk receptacle.

Preferably, during use, the steam wand also maintains a second spacing to a bottom of the milk receptacle.

Preferably, during use, the steam wand maintains a third spacing to the contact between the temperature sensor and the milk receptacle.

Preferably, the raised portion and recessed portion are configured such that the milk receptacle does not sit upright if resting on the receptacle support in a position other than the predetermined position.

Preferably, the temperature sensor has a contact face for contacting the base surface of the milk receptacle, and a biasing means to bias the contact face into engagement with the base surface when the milk receptacle is in the predetermined position.

Preferably, the temperature sensor has a diaphragm between the contact face and the recessed portion to provide a fluid seal while allowing limited movement of the contact face relative to the recessed portion.

Preferably, the temperature sensor is positioned on the steam wand.

There is further disclosed herein a coffee machine comprising:
an outlet for dispensing coffee;
a milk texturing device with a steam wand;
a support surface providing a generally planar surface to support a cup to receive coffee; and,
a receptacle support for supporting a milk receptacle in a predetermined position relative to the steam wand; wherein,
the receptacle support has a raised portion above the support surface to guide user placement of the milk receptacle into the predetermined position.

Preferably, the receptacle support provides a platform raised above the support surface.

Preferably, the raised portion is configured to surround the milk receptacle base.

Preferably, the receptacle support has a recessed portion lower than the raised portion, the recesses portion being configured to support the milk receptacle with the raised portion positioned at the periphery of the recessed portion.

Preferably, the recessed portion is lower than the support surface.

Preferably, the receptacle support is substantially within the support surface, the support surface having an array of apertures to drain liquid spillage into a drip tray.

Preferably, the coffee machine further comprises a temperature sensor for generating an output indicative of the temperature of indicative of the temperature of milk being textured in the milk receptacle.

Preferably, the temperature sensor is positioned to contact the milk receptacle base when in the predetermined position.

Preferably, the receptable support is positioned in the support surface to guide user placement of the milk receptacle such that the steam wand maintains a first spacing to an internal side of the milk receptacle.

Preferably, during use, the steam wand also maintains a second spacing to a bottom of the milk receptacle.

Preferably, during use, the steam wand also maintains a third spacing to the contact between the temperature sensor and the milk receptacle.

Preferably, the temperature sensor is positioned on the steam wand.

### BRIEF DESCRIPTION OF THE DRAWINGS

Preferred embodiments of the present invention will now be described, by way of example only, with reference to the accompanying drawings, in which:

FIG. 1 is a perspective of a first embodiment of a coffee machine with extraction module and steam module together with a drip tray assembly;

FIG. 2 shows the coffee machine of FIG. 1 with the drip tray assembly spaced from the extraction module and steam module;

FIG. 3 is another perspective of the coffee machine shown in FIG. 1 showing the configuration of the drip tray assembly support surface;

FIG. 4 is a perspective of the coffee machine shown in FIG. 1 with the movable cup support detachably connected to the extraction module and separated from the drip tray assembly;

FIG. 5 is a section view of the coffee machine shown in FIG. 1 illustrating the movable cup support detachably connected to the extraction module in its lowest position together with the drip tray assembly;

FIG. 6 is a perspective of the drip tray assembly shown in isolation;

FIG. 7 is a cross-section of the extraction module showing the sockets used for detachable connection with the movable cup support;

FIG. 8 is a perspective of the coffee machine with the movable cup support in the most elevated position and separated from the support surface of the drip tray assembly;

FIG. 9 is a perspective of the coffee machine of FIG. 1 without the drip tray assembly;

FIG. 9A is a perspective view of a coffee machine with an extraction module and a drip tray assembly;

FIG. 9B is a perspective view of the coffee machine shown in FIG. 9A with the movable cup support in an elevated position and separated from the support surface of the drip tray assembly;

FIG. 9C is a perspective view of the coffee machine shown in FIG. 9A with the movable cup support in an elevated position and with the drip tray assembly spaced from the extraction module;

FIG. 9D is a perspective view of the coffee machine shown in FIG. 9A with the movable cup support resting in the spaced drip tray assembly;

FIG. 10 is a perspective of the coffee machine shown in FIG. 9 with a second embodiment of the drip tray assembly;

FIG. 11 is a perspective of the coffee machine with the coffee drip tray detachably connected to the extraction module at its highest elevation, and without the steam drip tray;

FIG. 12 shows the coffee machine with the steam drip tray and without the coffee drip tray;

FIG. 13 shows the coffee machine with the coffee drip tray in the most elevated position and the steam drip tray beneath the steam wand of the steam module;

FIG. 14 shows the coffee machine with the coffee drip tray in the lowest position and without the steam drip tray;

FIG. 14A is a perspective view of a coffee machine with another embodiment of the drip tray assembly with the movable cup support resting in the drip tray assembly;

FIG. 14B is a perspective view of the coffee machine shown in FIG. 14A with the movable cup support in an elevated position;

FIG. 14C is a perspective view of the coffee machine shown in FIG. 14A with the movable cup support in an elevated position, and without the coffee drip tray;

FIG. 14D is a perspective view of the coffee machine shown in FIG. 14A with the movable cup support in an elevated position, and without the steam drip tray;

FIG. 15 is a tray assembly according to the first embodiment from the alternative perspective;

FIG. 16 shows the drip tray assembly of FIG. 15 with the movable cup support and the support surface removed to reveal the liquid level indicator in the “empty” position;

FIG. 17 shows the partial drip tray assembly of FIG. 16 with the liquid level indicator in the “full” position;

FIG. 18 is a cross-section view through the drip tray assembly according to the first embodiment at the steam module;

FIG. 19 is cross-section of the drip tray assembly shown in FIG. 15 with the liquid level indicator raised to the “full” position;

FIG. 20 is a cross-section of the drip tray assembly shown in FIG. 15 with the liquid level indicator lowered in the “empty” position;

FIG. 21 is an exploded perspective view of the drip tray assembly according to the first embodiment shown in FIG. 15;

FIG. 22 is a cross-section through the drip tray assembly according to the first embodiment at the extraction module;

FIG. 23 is a perspective of the drip tray assembly according to the second embodiment with the support surface and movable cup support removed to reveal the baffle structure beneath the stop;

FIG. 24 is an exploded perspective of the drip tray assembly according to the second embodiment;

FIG. 25 is a vertical cross section across both the extraction module, the steam module and intervening cord storage cavity;

FIG. 26 is a vertical cross section through the cord storage cavity between the extraction module and the steam module;

FIGS. 27 and 28 are further vertical cross sections through the cord storage cavity between the extraction module and the steam module;

FIG. 29A is a schematic representation of a milk jug correctly located beneath the steam wand of a milk texturing device according to the prior art;

FIG. 29B is the milk jug incorrectly located beneath the steam wand of the milk texturing device shown in FIG. 29A;

FIG. 30A is a schematic representation of a milk jug correctly located beneath the steam wand by nesting in a recess in the supporting drip tray assembly;

FIG. 30B is a schematic representation of the milk jug incorrectly located beneath the steam wand of the milk texturing device shown in FIG. 30A such that the temperature sensor no longer contacts the milk jug;

FIG. 31A is a schematic representation of a milk jug correctly positioned beneath the steam wand of the milk texturing device through being placed in registration with a raised platform on the supporting drip tray assembly;

FIG. 31B shows an incorrectly located milk jug beneath the steam wand of the milk texturing device of FIG. 31A in which the temperature sensor no longer contacts the milk jug;

FIG. 32A is a schematic representation of a milk jug correctly positioned beneath the steam wand of a milk texturing device by locating the jug bottom on the supporting drip tray using a peripheral raised portion around the correct jug location;

FIG. 32B is a schematic representation of a milk jug incorrectly positioned beneath the steam wand of the milk texturing device shown in FIG. 32A which the temperature sensor no longer contacts the bottom of the jug;

FIG. 33 is a perspective of a coffee machine having a coffee extraction module and a steam module with the milk jug correctly placed under the steam wand;

FIG. 34 shows the coffee machine of FIG. 33 with the milk jug removed to reveal the jug support surface with peripheral raised portion;

FIG. 35 is an enlarged partial perspective of FIG. 34 showing the aperture support surface on the drip tray surrounding the receptacle support for the milk jug;

FIG. 36 is a plan view of the perspective shown in FIG. 35 with the milk jug correctly located beneath the steam wand using the peripheral raised portion of the receptacle support;

FIG. 37 is a sectioned view of the plan view shown in FIG. 36 showing the end tip of the steam wand spaced from the side wall of the milk jug, the bottom of the milk jug and the area of contact between the bottom of the milk jug and the temperature sensor;

FIG. 38 is a sectioned view similar to FIG. 37 in which the milk jug is incorrectly positioned beneath the steam wand and clearly sitting askew on the supporting surface of the drip tray;

FIG. 39 is a schematic plan view of a lateral flow pattern in the jug; and

FIG. 40 is a schematic vertical section view of flow patterns in the jug.

### DESCRIPTION OF EMBODIMENTS

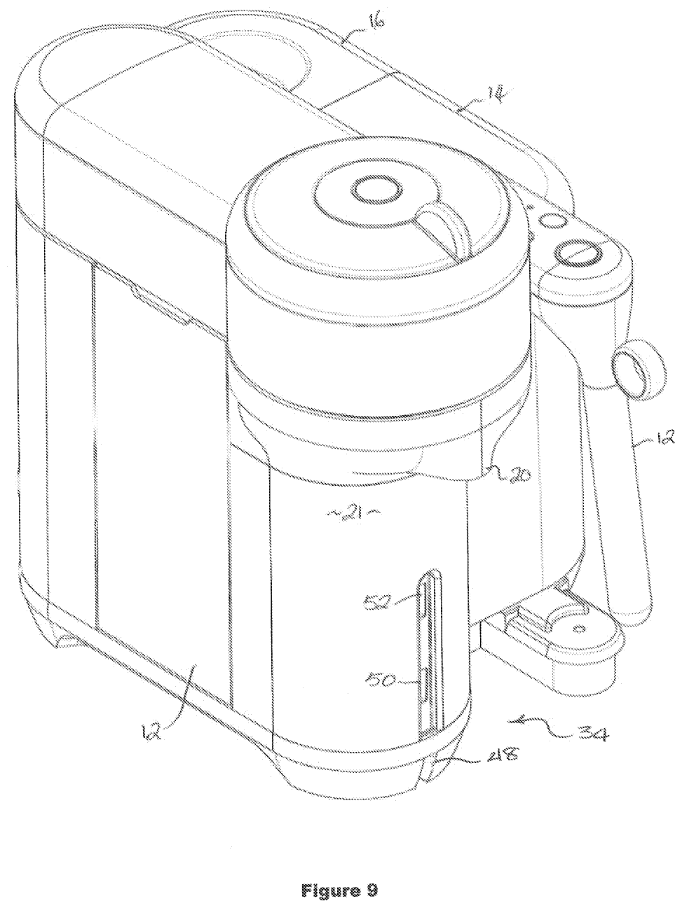

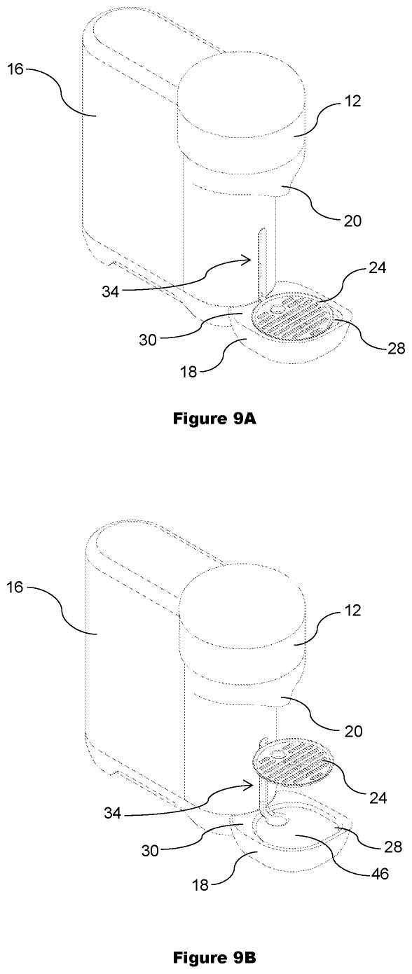

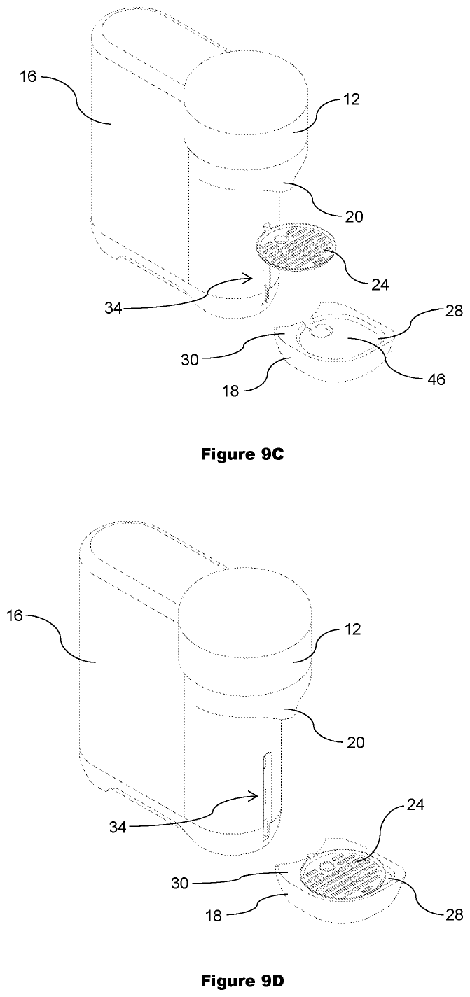

Referring to the Figures, there is schematically depicted a coffee machine 10 having an extraction module 12 and a steam module 14. A single water tank 16 supplies both the extraction module 12 and the steam module 14. Likewise, a single drip tray assembly 18 collects spillage from the coffee extraction and the milk frothing (also referred to ‘milk texturing’) processes. It will be appreciated that in other embodiments, the extraction module 12 may be a standalone device supplied with the water tank 16 and the drip tray assembly 18. This is best shown in the embodiment depicted in FIGS. 9A, 9B, 9C, and 9D, in which the drip tray assembly 18 is shown as a dedicated drip tray assembly for the extraction module 12. It will be understood that the embodiment depicted in FIGS. 9A, 9B, 9C, and 9D may include one or more of the other features shown in relation to the other embodiments and as described below. Likewise, the steam module 14 may be a standalone device supplied with the water tank 16 and the drip tray assembly 18.

In the depicted embodiment, the coffee machine 10 shown is a capsule or pod machine that uses sealed capsules of ground coffee to extract a dose of espresso coffee. However, the invention is not limited to capsule machines and may be applied to other types of coffee machines.

The user opens a removable top 86 on the extraction module 12 and inserts a capsule of ground coffee. Normally, a range of capsules are available for use with capsule machines to provide a variety of different espresso doses. The coffee and the capsules may have differing coffee bean blends, grinds (degree of fineness or coarseness or compaction) and different amounts of coffee to provide the different styles of extracted coffee. More sophisticated capsule machines identify the capsule inserted and optimum extraction settings are automatically used.

The extraction module 12 has a dispensing spout 20 for dispensing the dose of coffee, and a supporting body 21 to position the dispensing spout 20 at an elevated position above the benchtop to accommodate cups and receptacles (such as a carafe) of various heights. If a short black coffee in a demi-cup is required, the small cup should be closer to the dispensing spout 20 than a long black in a regular cup in order to avoid excessive splashing and spillage. A movable cup support or platform 24 can be positioned at different positions beneath the dispensing spout 20.

In the various embodiments of the coffee machine 10 shown, the cup support 24 is configured for detachable connection with the supporting body 21 of the extraction module 12 in any one of the sockets 34 beneath the spout 20. In other forms, the cup support 24 need not detach and may be retained on the supporting body 21 for movement beneath the spout. However, as a detachable component, the cup support 24 is more easily cleaned and stored than a permanently connected component.

In the embodiments of the coffee machine 10 which include the steam module 14, the support surface 30 of the drip tray assembly 18 has a milk jug recess 42 on the steam module side in order to accurately locate the milk jug during the frothing operation. The extraction side of the support surface 30 includes a recess 46 corresponding to the platform or body 38 of the movable cup support 24. The platform 38 of the movable cup support 24 has apertures that generally correspond to the support surface apertures 32, however any spillage through the platform 38 drains through the drain holes 47 in the recess 46 before collecting in the tray 60.

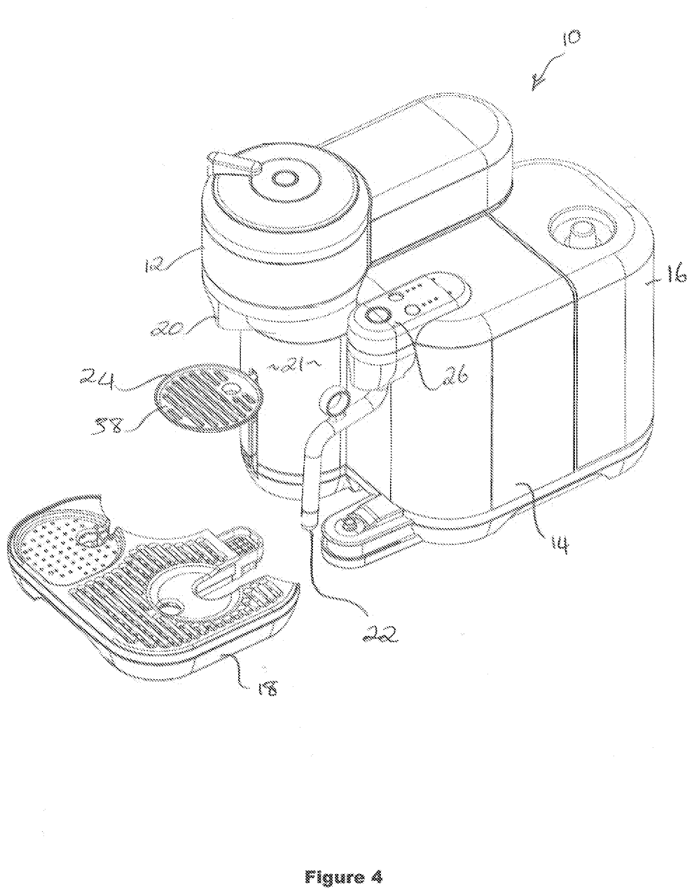

As best shown in FIGS. 4, 5 and 6, the cup support 24 has a platform 38 for supporting a cup and a protrusion or tongue 36 for detachable connection with any one of the sockets 34 in the supporting body 21. As best shown in FIG. 5, the lowest socket 48 has a slightly different configuration to the middle socket 50 and the upper socket 52. In the lower position, the cup support 24 is resting on the drip tray assembly 18 so that the platform 38 is substantially co-planar with the support surface 30 of the drip tray assembly 18. When the drip tray assembly 18 is slid into position beneath the dispensing spout 20, the protrusion 36 from the cup support 24 slides horizontally into the lower socket 48. When the cup support 24 is lifted away from the drip tray assembly 18 and inserted in the middle socket 50 or upper socket 52, the protrusion 36 is slid into the socket at an incline such that the weight of the cup support 24 and the cup itself help retain the protrusion 36 in engagement with the sockets 50 or 52. Regardless of whether the cup support 24 is engaged with the sockets 48, 50 or 52, the platform 38 is held in a horizontal orientation to provide a flat surface for the cup. In another embodiment, similar to the lowest socket 48, the sockets 50 and/or 52 allow the cup support 24 to be slid horizontally from and into the sockets 50 and/or 52.

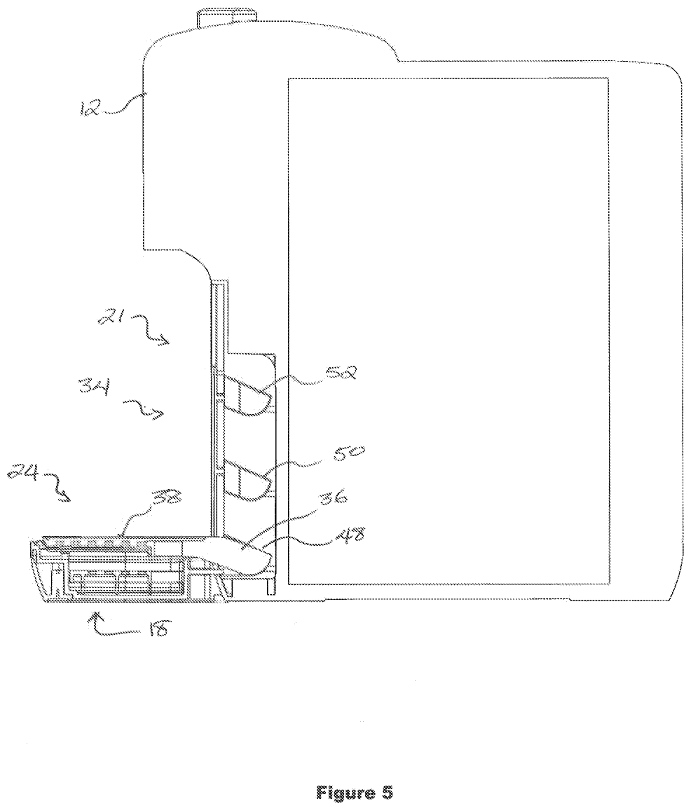

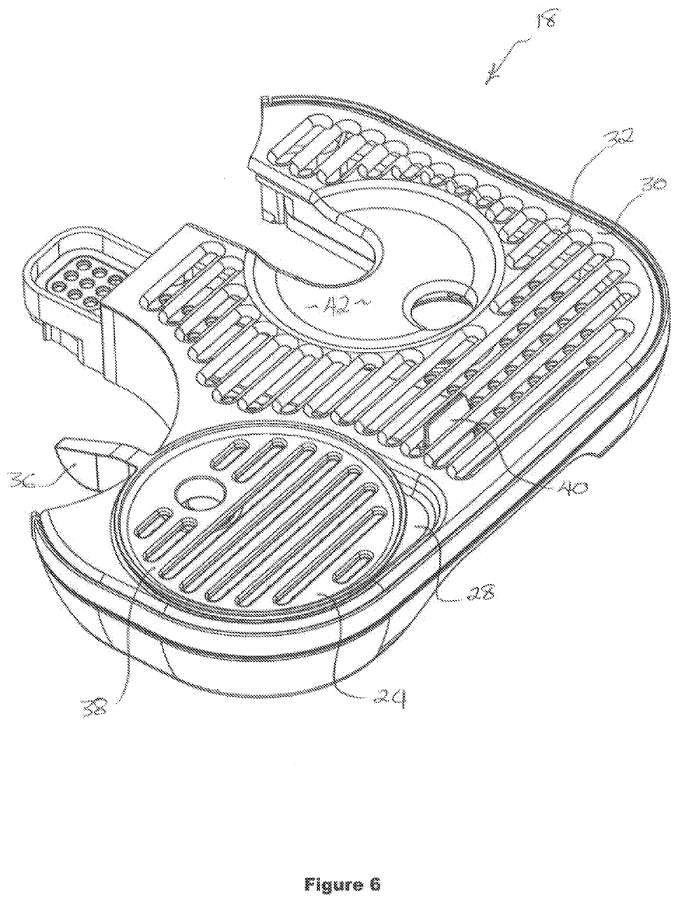

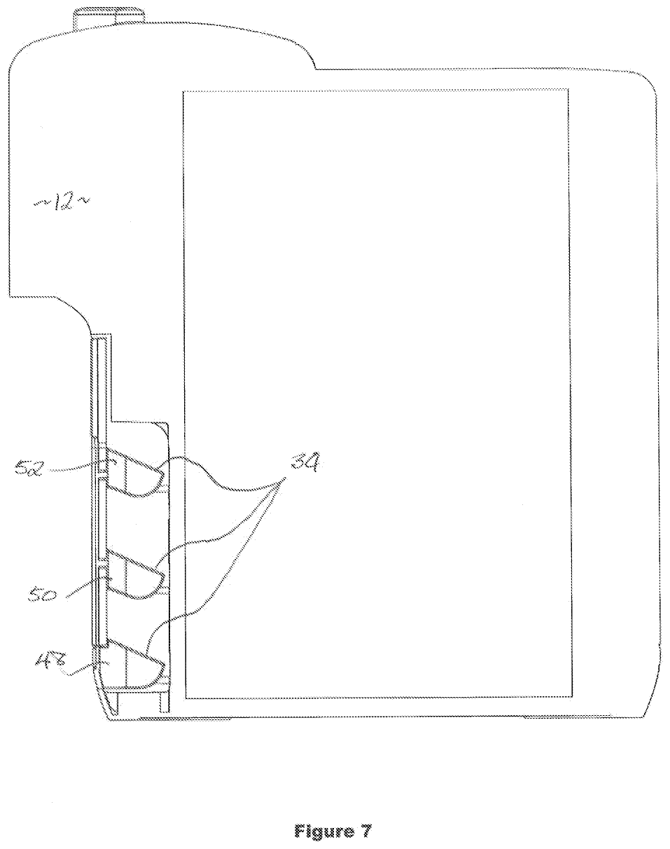

As best shown in FIGS. 6,8, 9A, 9B, 9C, and 9D, the drip tray assembly 18 includes a finger recess 28 formed in the support surface 30. This allows the user to lift and remove the cup support 24 while the drip tray assembly 18 remains in place beneath the dispensing spout 20 and the steam wand 22.

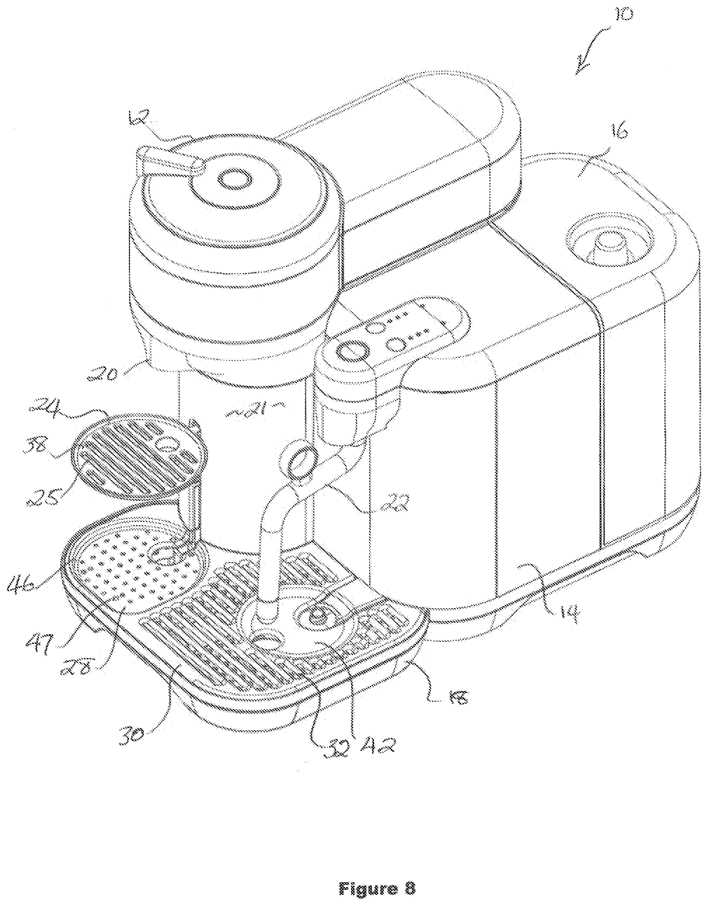

As best shown in FIG. 8, the finger recess 28 forms part of a larger cup support recess 46 shaped to correspond with the platform 38. As discussed above, when the platform 38 rests in the cup support recess 46, the platform and the support surface 30 of the drip tray assembly 18 are substantially co-planar. Similarly, the drainage slots 25 provided in the platform 38 generally correspond to the configuration and spacing of the support surface apertures 32. However, any drainage through the slots 25 also need to pass through the drainage holes 47 formed in the cup support recess 46.

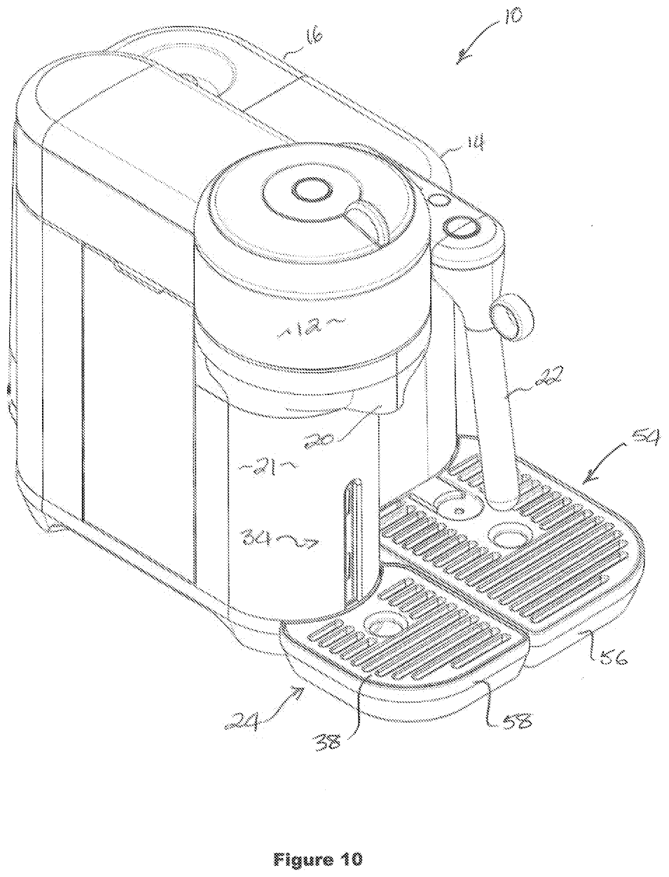

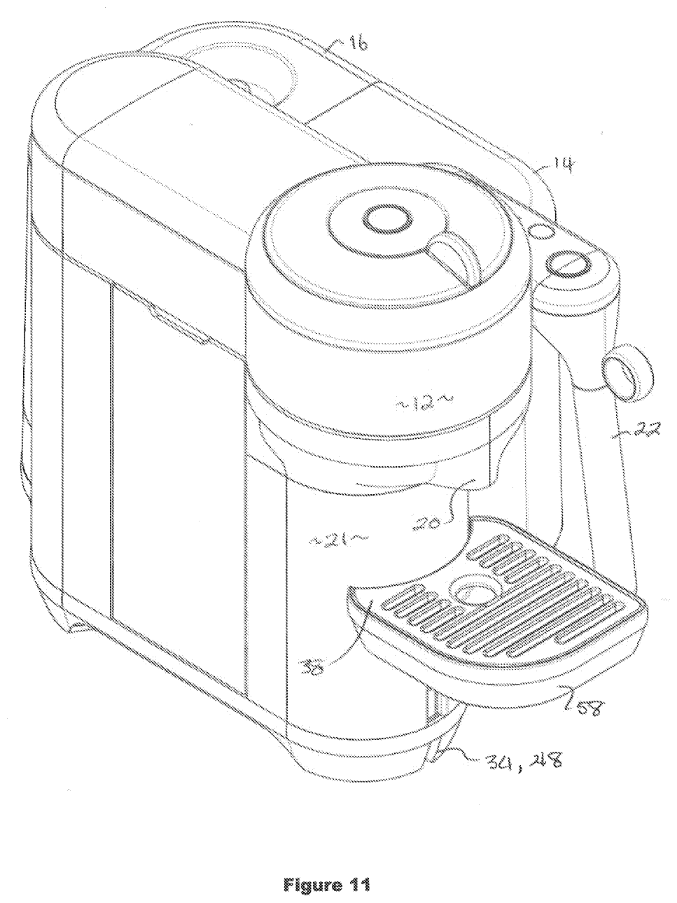

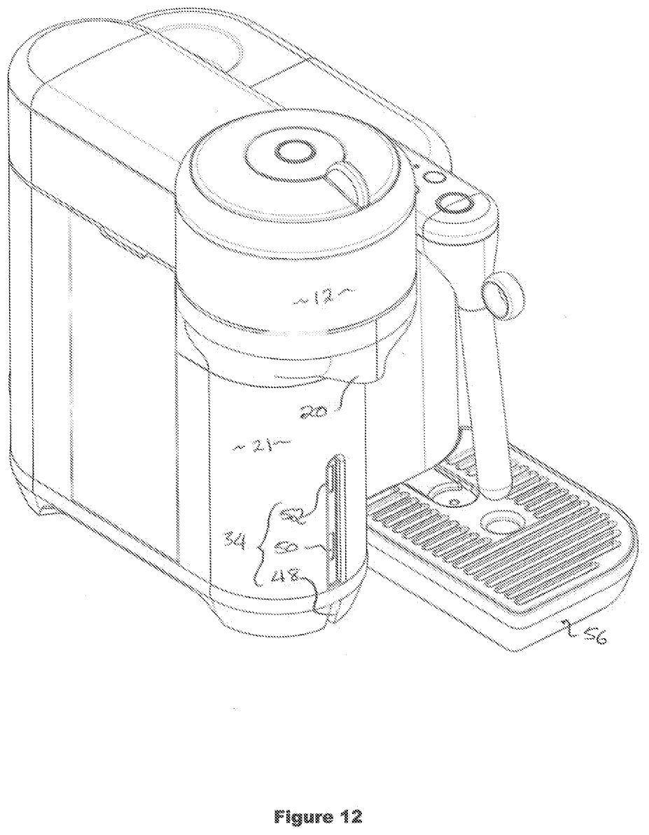

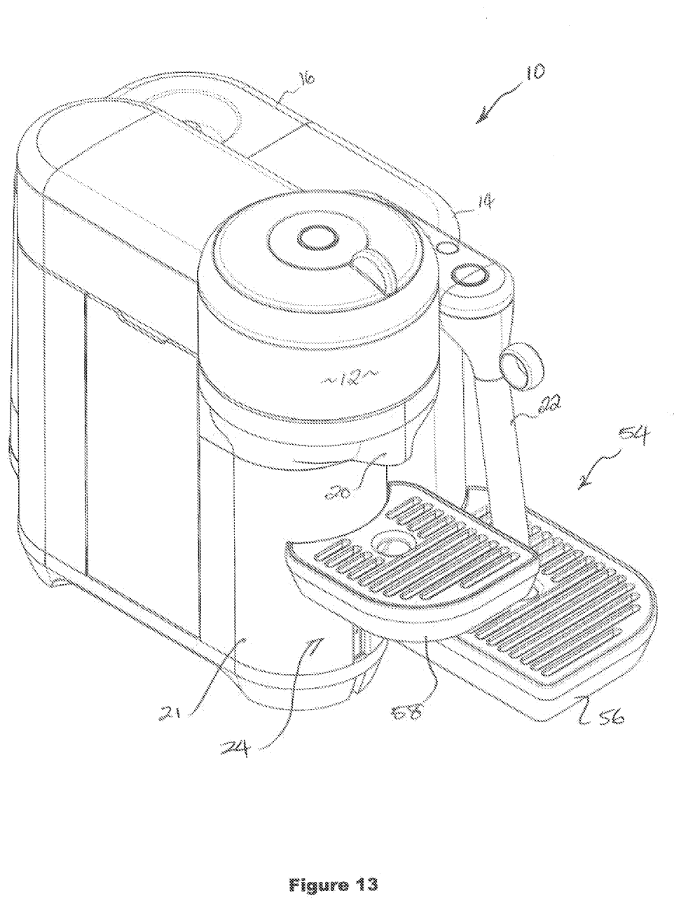

FIGS. 10, 11, 12, 13, 14, 23 and 24 show an alternative arrangement of the drip tray assembly 54. In this form, the drip tray assembly 54 is a combination of a milk (or steam) drip tray 56 and a coffee drip tray 58. In this form, the coffee drip tray 58 moves together with the cup support to the various positions beneath the dispensing spout 20. This configuration allows the separate drip trays to be individually emptied and cleaned. Furthermore, having a gap between the platform 38 and the support surface 30 of the drip tray (as is the case with the first embodiment of the drip tray 18 when the socket 50 or 52 is used), coffee dripping to the support surface 30 can splash onto the adjacent benchtop. Alternatively, the platform 38 moves separately from the coffee drip tray 54 to the various positions beneath the dispensing spout 20. The platform 38 can be separately cleaned from the coffee drip tray 54.

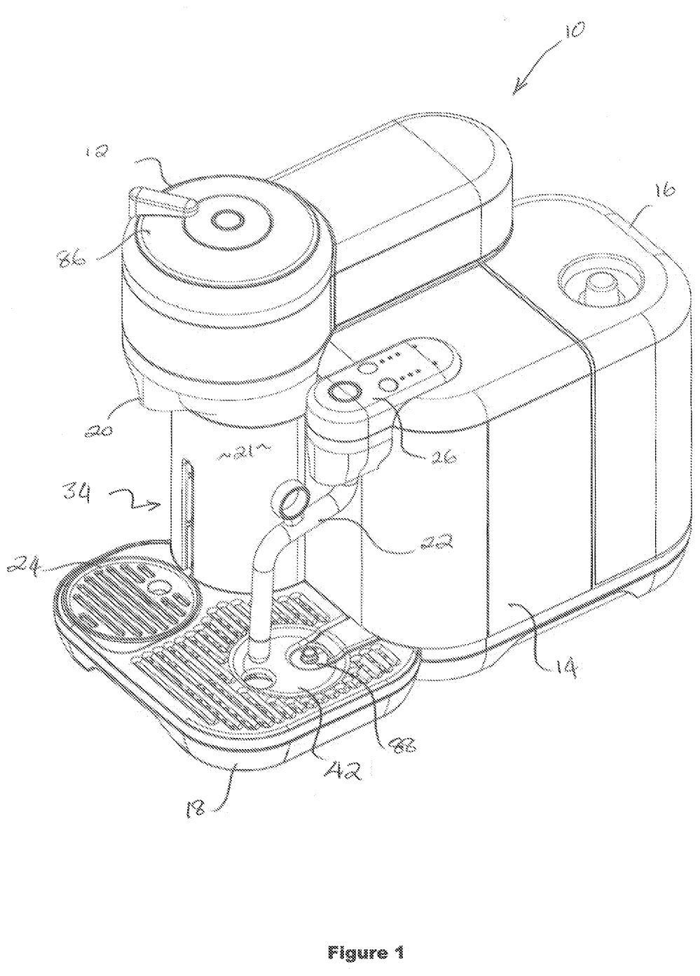

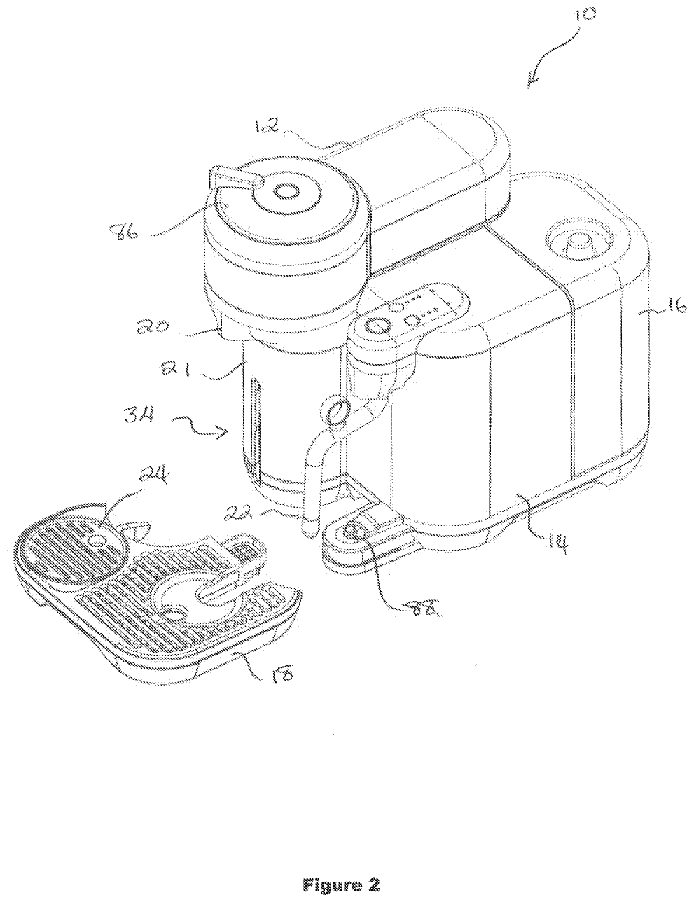

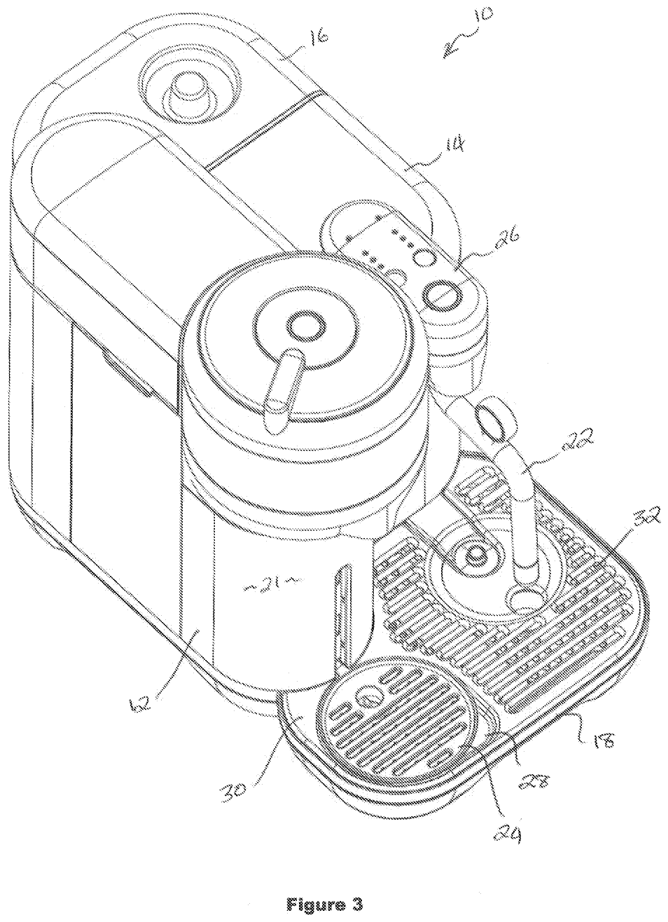

The dual drip tray used by drip tray assembly 54 can have advantages in terms of preventing spillage and overflow particularly when preparing coffee drinks that require more water such as Americanos and long blacks. There can be significant spillage from these coffees if the user mistakenly places the wrong sized cup on the coffee drip tray 58. If this occurs, the user can remove the coffee drip tray 58 while the milk drip tray 56 remains in place thereby not disturbing any milk texturing operations. In this way, the user is more inclined to empty the coffee drip tray more frequently and usually immediately after the spillage has occurred. Hence, less spilled coffee may accumulate in a dual drip tray arrangement, compared to the drip tray assembly 12 of FIG. 1.

Another advantage of the dual drip tray assembly 54 is the ability to remove the coffee drip tray 58 such that a coffee carafe (not shown) will fit beneath the dispensing spout 20. This allows the milk drip tray 56 to remain in place for simultaneously frothing milk while the carafe fills.

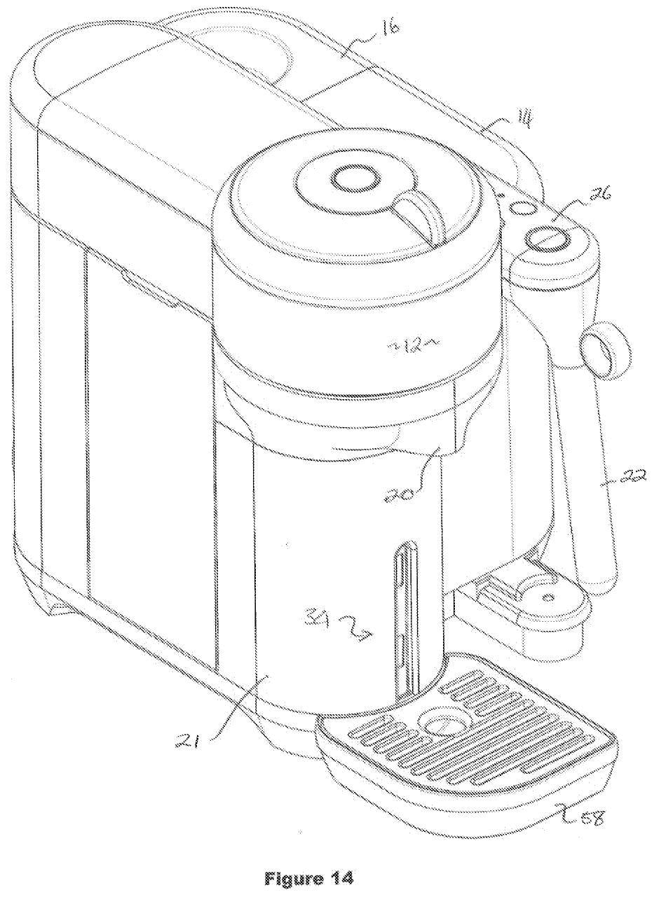

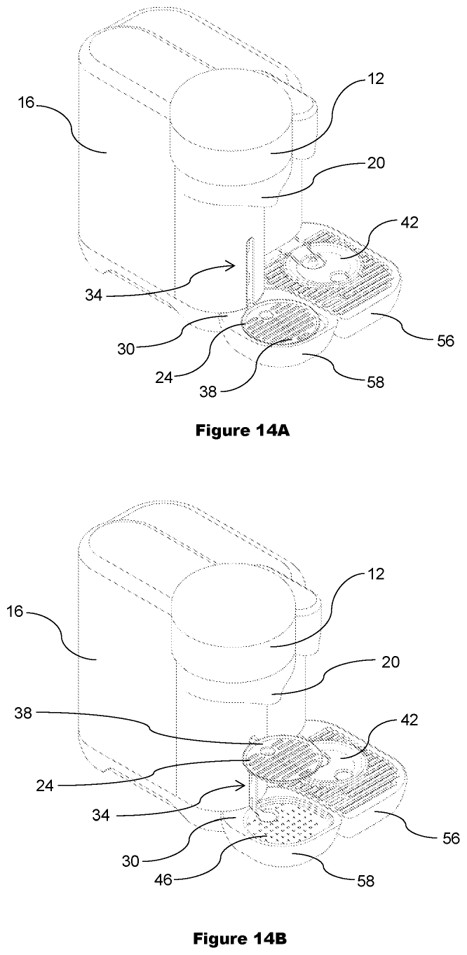

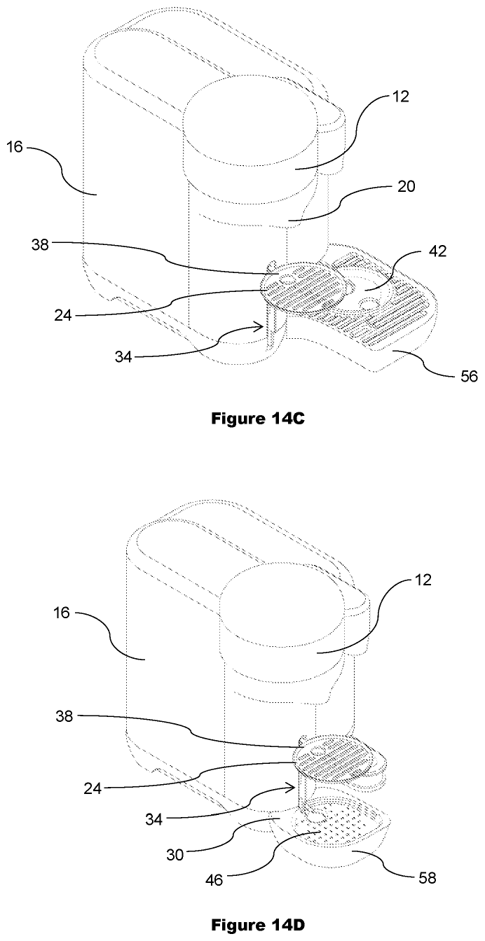

FIGS. 14A, 14B, 14C, and 14D show an alternative arrangement of a dual drip tray assembly in which the coffee drip tray 58 includes a cup support recess 46 shaped to correspond with the platform 38 of the cup support 24 as described above. When the cup support 24 or its platform 38 rests in the cup support recess 46, the cup support 24 or its platform 38 and the support surface 30 of the drip tray assembly 18 are substantially co-planar. In this embodiment, the steam drip tray 56 also includes the milk jug recess 42 in order to accurately locate the milk jug during the frothing operation.

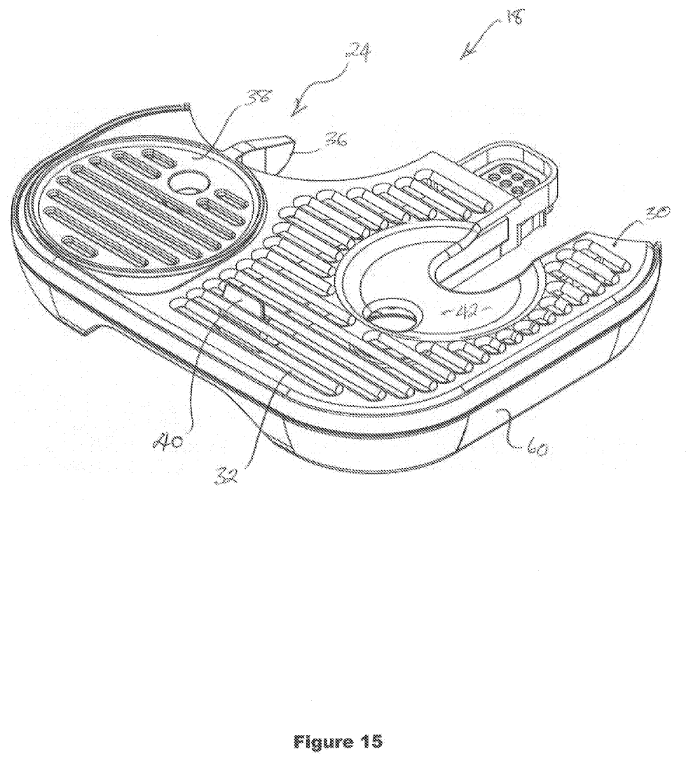

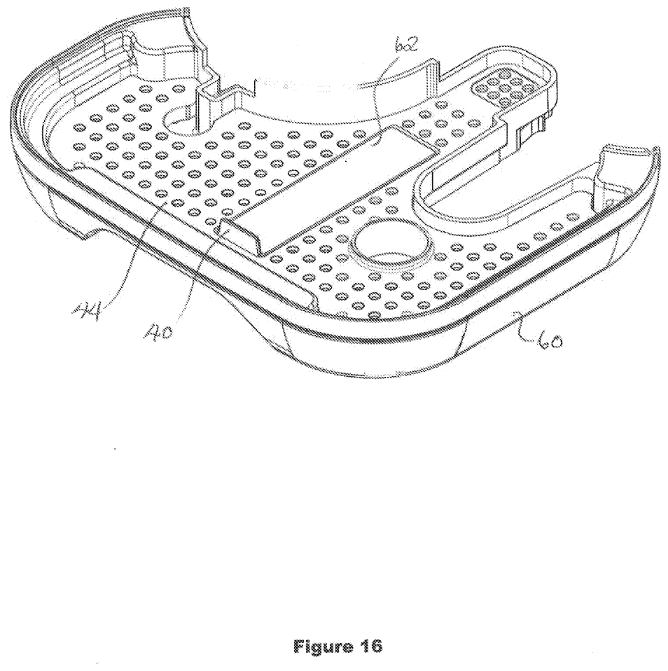

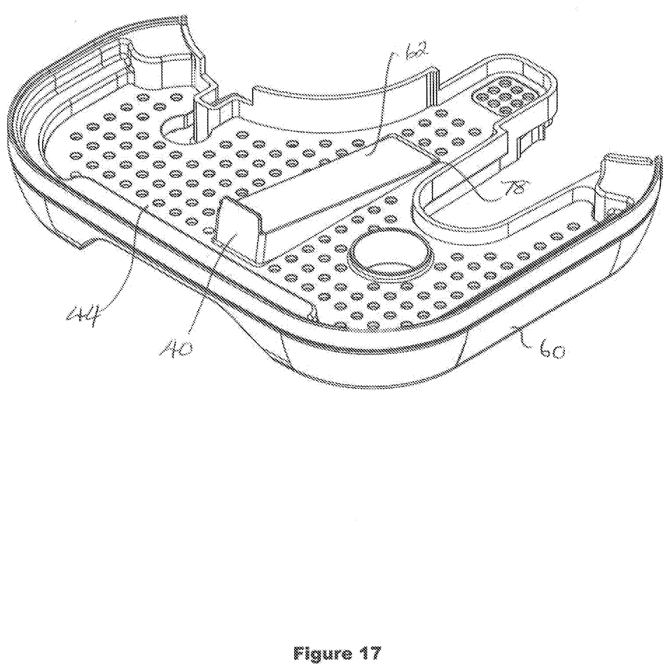

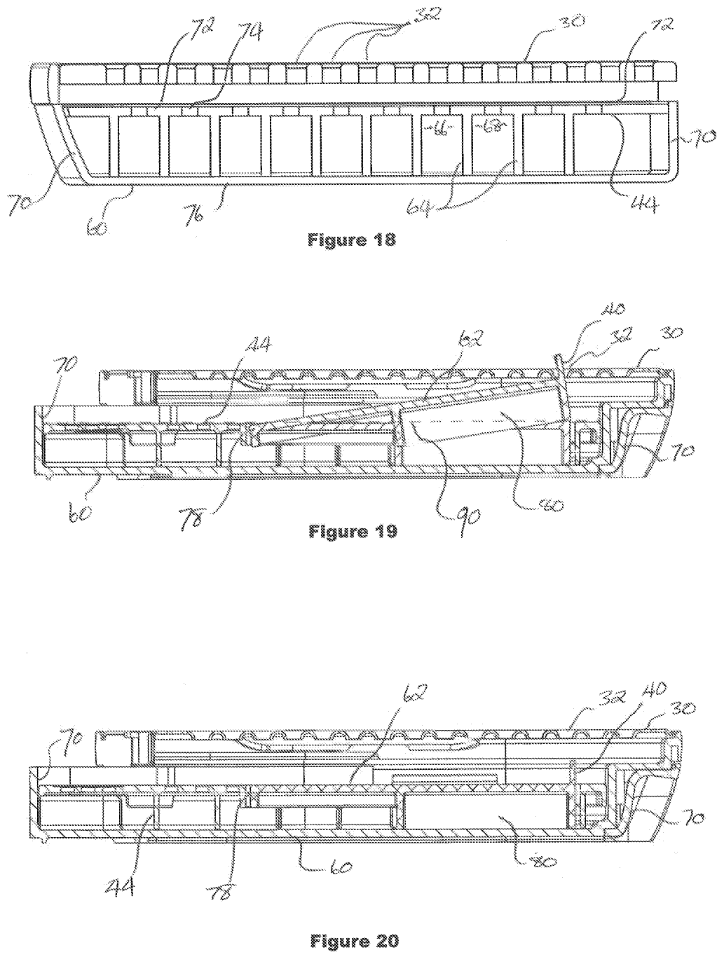

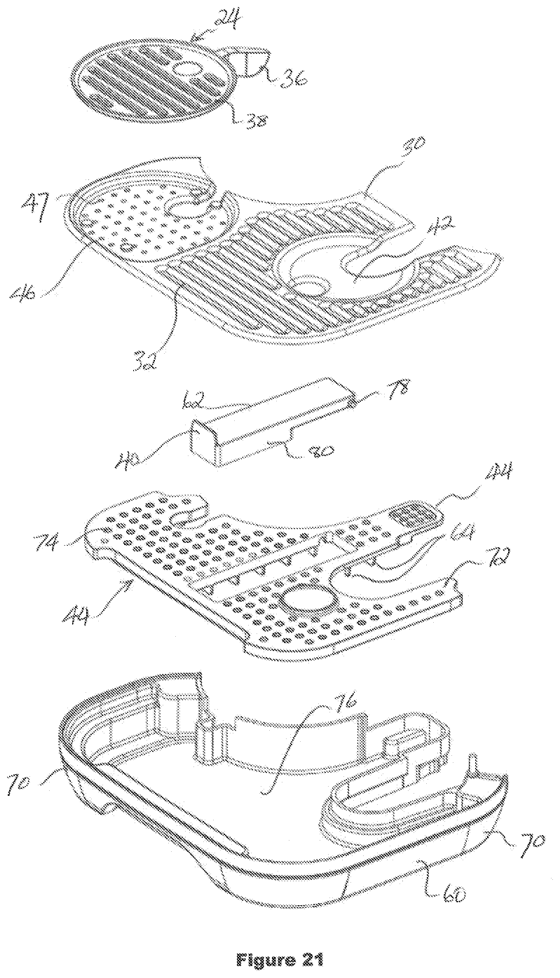

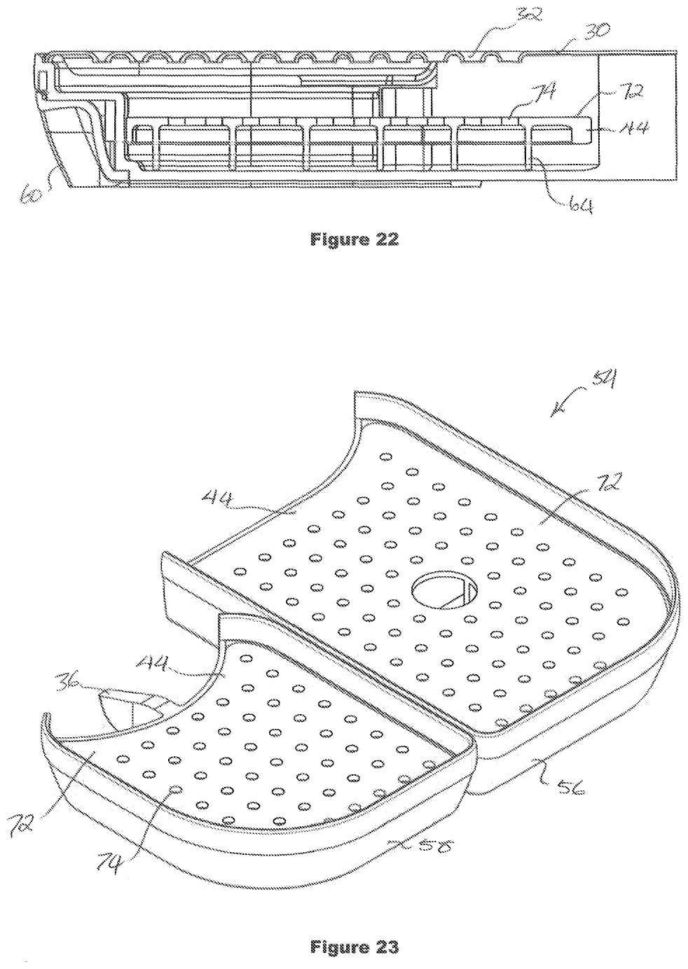

Referring to FIGS. 15 to 22, the features of the combination drip tray assembly 18 is shown in detail. As best shown in FIG. 21, a reservoir or tray 60 sits at the base of the drip tray assembly 18. The tray 60 has a broad flat tray floor 76 with upwardly extending peripheral side walls 70. A baffle structure 44 sits within the tray 60 such that the lower edges of the baffles 64 abut the tray floor 76. The baffles 64 are a series of fins extending downwards from a baffle plate 72. The baffle plate 72 defines an array of baffle plate holes 74 (see in particular FIG. 18). Any spillage drains through the support surface apertures 32 onto the baffle plate 72 where they drain through the baffle plate holes 74 to collect in the tray 60. The baffle plate 72 can either be integrated with or separated from the tray 60.

As shown in FIG. 18, the baffles 64 divides the reservoir formed by the tray 60 into a series of adjacent sections, (see for example 66 and 68). When the drip tray assembly 18 is manually slid away from the rest of the machine 10, inertia causes the collected liquid to flow towards the sidewall 70. If the entire volume of liquid flows to the sidewall opposite the direction of movement, the chance of liquid spilling over is increased. The baffle structure 44 segments the reservoir into adjacent sections 66 and 68. The baffles 64 provide at least some obstruction to the flow between sections of the reservoir to reduce the chance of spillage at the sidewalls of the tray 60.

Similarly, when the user is manually lifting the drip tray assembly 18 away from the coffee machine to drain the contents, any liquids in one section 66 of the reservoir 60 will be unable to flow directly to the side wall or the adjacent section 68 of the reservoir into the baffles 64. This effectively provides the user with additional time to move the drip tray assembly 18 to a sink before spillage over the edge of the side wall occurs in response to tilting the tray away from horizontal. However once at sink, the drip tray assembly 18 is quick and easily disassembled for cleaning.

In the embodiment as shown in FIGS. 19 and 20, the drip tray assembly 18 includes a liquid level indicator 62. The liquid level indicator 62 is an elongate body with a pivot connection 68 to the baffle structure 44 at one end and a visual indicator 40 at the other. Between the connection 78 and the visual indicator 40 is a buoyant section 80 to rotate the liquid level indicator 62 as the liquid level in the drip tray 60 rises. By providing a relatively long liquid level indicator 62 with the pivot connection 78 and the visual indicator 40 and opposing ends, the visual indicator 40 moves in a wide arc and will easily move through the support surface aperture 32 because its movement is approximately vertical. Furthermore, the visual indicator 40 can be configured as a relatively wide element that protrudes from a support surface aperture 32 that is near the front of the drip tray assembly for added visual prominence to the user. Using a strongly contrasting colour, or a high visibility colour makes the appearance of visual indicator 40 through the support surface 30, more apparent to the user.

As best shown in FIG. 21, the pivot connection 78 to the baffle structure 44 is detachable such that the baffle structure and liquid level indicator 62 can be separated for more thorough and convenient cleaning. Alternatively, the liquid level indicator 62 can be integrated with the baffle structure 44.

FIG. 19 shows the liquid level 90 at which the visual indicator 40 will extend through the support surface aperture 32 to a maximum extent. Of course, the liquid level could rise above the level 90, however it is prudent to flag the need to empty the drip tray assembly 18 before the level approaches the top of the side walls 70.

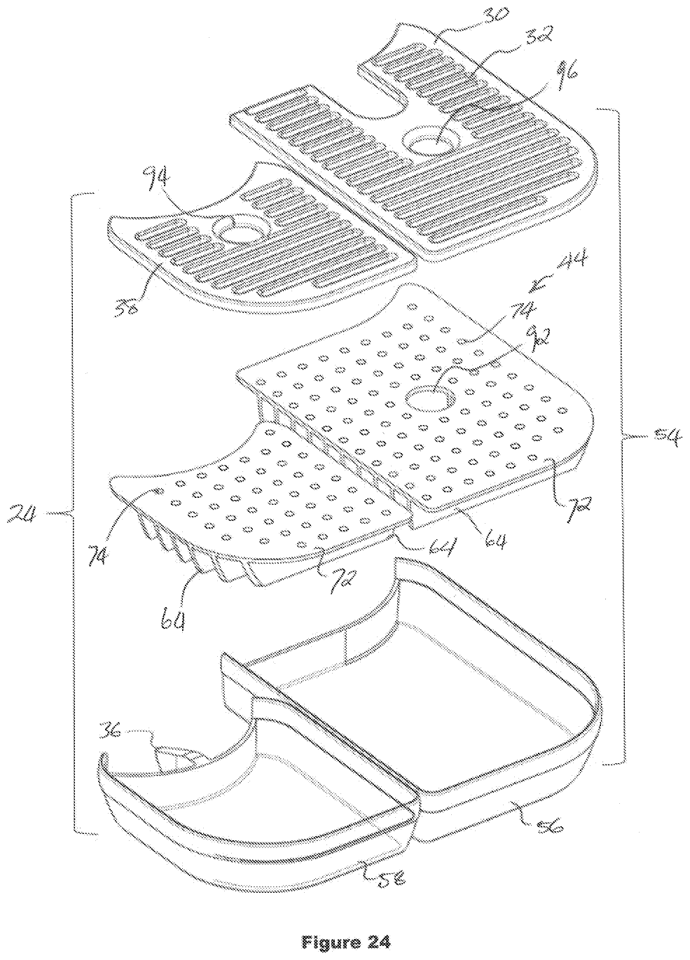

Referring to FIGS. 23 and 24, the dual drip tray assembly 54 is shown in detail. As discussed above, the dual drip tray assembly 54 includes a milk drip tray 56 and separate coffee drip tray 58. The coffee drip tray 58 is configured such that it provides the movable cup support 24. In light of this, the protrusion 36 is an integrally moulded plastic feature of the tray 58 rather than the platform 38 as is the case with the combined drip tray 18. Alternatively, the protrusion 36 could be integrated with the cup support 38.

In the dual drip tray assembly 54, the milk drip tray 56 and the coffee drip tray 58 each have separate baffle structures 44. As with the previous embodiment, the baffle structures 44 have a baffle plate 72 with an array of baffle plate holes 74. A series of baffles 64 extend from the underside of the baffle plate 72. To aid removal of the baffle structure 44 from the drip tray 56, a finger hole 92 may be provided. Similarly, the platform 38 is provided with a finger hole 94 as is the support surface 30 (see finger hold 96).

As with the previous embodiment, the baffle structures 44 separate the trays 56 and 58 into sections such that the flow of spilt liquid in one section is at least partially restricted from flowing to another section when the tray is tilted. This helps the user slide the drip trays 56 and 58 away from the extraction and steam modules 12 and 14 without any spillage.

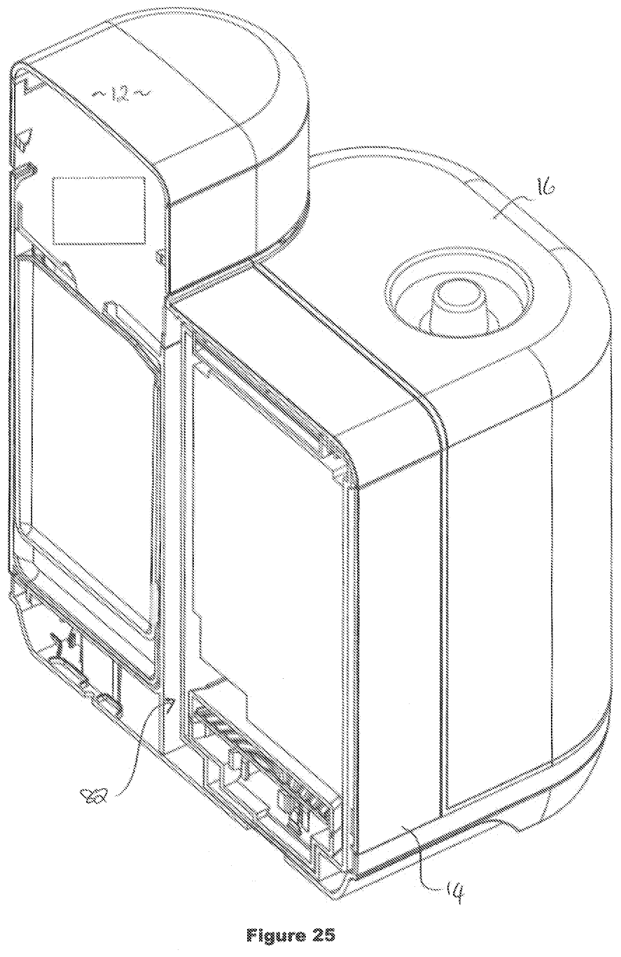

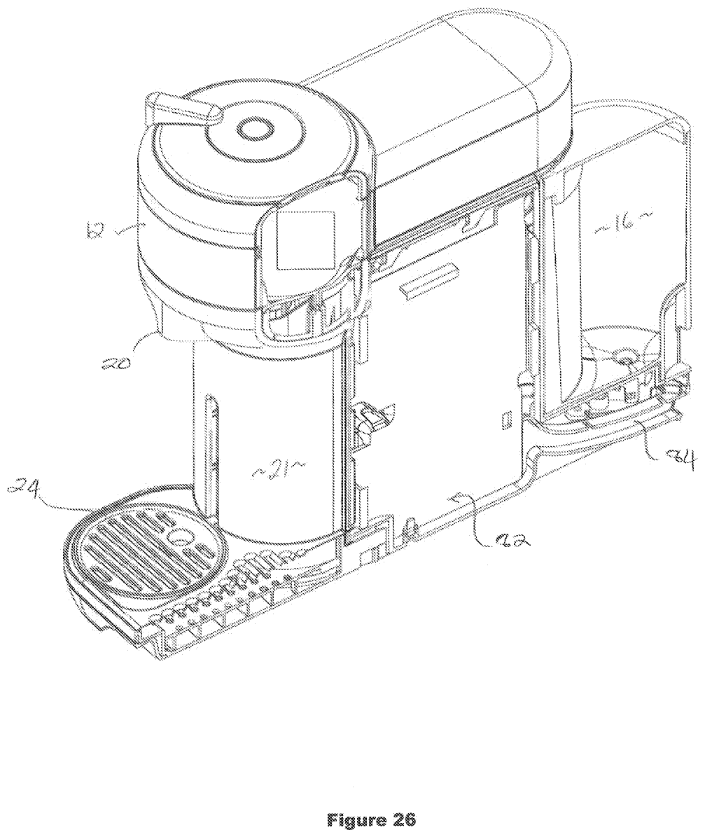

Referring to FIGS. 25 and 26, partial section views of the coffee machine 10 are shown to depict the orientation of the cord storage cavity 82. Vertically orienting the cord storage cavity 82 and positioning it between the extraction module 12 and the steam module 14 provides a degree of thermal insulation such that the operation of the steam module 14 does not interfere with the operation of the extraction module 12 and vice versa. As best shown in FIG. 26, a power cord 83 of the coffee machine 10 extends through a cord channel 84 to the rear of the machine 10, beneath the water tank 16. In the depicted embodiment, the storage cavity 82 has a vertical dimension that is greater than the horizontal dimension extending in a direction of the lateral spacing between the extraction module and the steam module. In a preferred form, the vertical dimension substantially exceeds the horizontal dimension.

By storing the cord in a cavity that is vertically oriented removes the need for a horizontal cord storage cavity and therefore reduces the overall height of the appliance. The reduced height allows the coffee machine 10 to be stored in shelving with a reduced spacing.

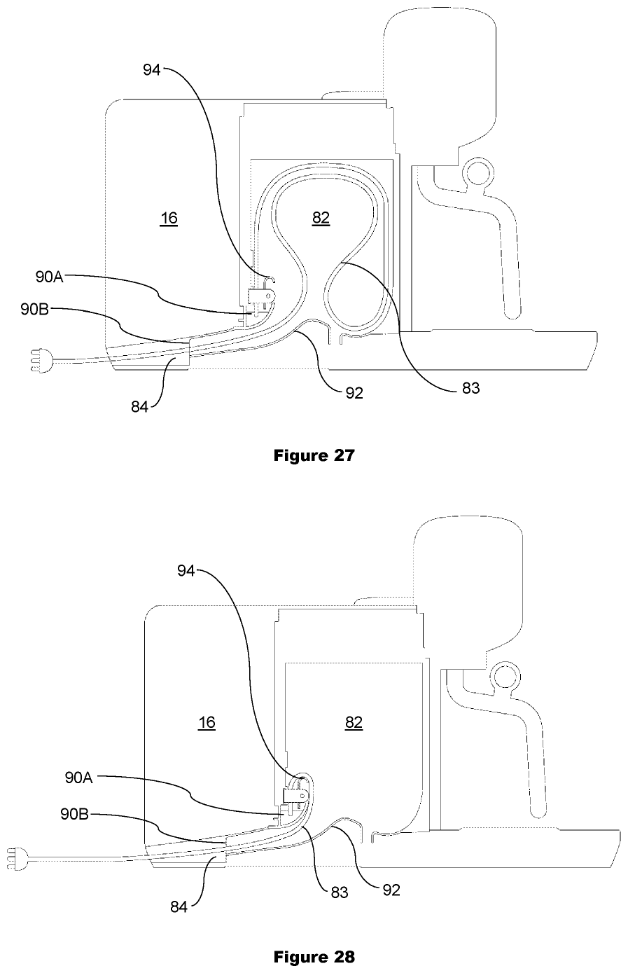

In FIGS. 27 and 28, there is schematically depicted an embodiment of the storage cavity 82 having a first opening 90A and a second opening 90B to accommodate the cord 83. The first opening 90A leads to the internal electronics/circuitry of the coffee machine 10 from which the cord 83 extends from. The second opening 90B leads to the cord channel 84, which in turn leads to the exterior of the coffee machine 10. It will be understood that the cord 83 is thus extendable from the internal electronics/circuitry of the coffee machine 10, through the first opening 90A and into the storage cavity 82, and exits the coffee machine 10 via the second opening 90B and the cord channel 84. At the exterior of the machine 10, the cord 83 terminates in a plug for connection to a wall socket.

The storage cavity 82 may further include one or more tracks 92 for maintaining the cord 83 in a desired orientation in the storage cavity 82, so as to avoid to prevent entanglement of the cord 83, for example. The one or more tracks 92 may guide the movement of the cord 83 when the user pulls the cord 83 out of the storage cavity 82, or when they push the cord into the storage cavity 82. The one or more tracks 92 may have curved or rounded portions to promote smooth movement of the cord 83.

The storage cavity 82 may also further include one or more guide portions 94 to provide additional guidance or protection for the cord 83 during movement into and out of the storage cavity 82. The one or more guide portions 94 may be located in a path of the cord 83 within the storage cavity 82 and adjacent the first opening 90A, for example. In a preferred form, the one or more guide portions 94 may be located adjacent a sharp component located within the storage cavity 82, whereby the one or more guide portions 94 may shield or protect the cord 83 from becoming excessively bent or damaged by the sharp component when the cord 83 is being moved into and out of the storage cavity 82. In the depicted embodiment, the guide portion 94 is shown in the form of a hook to provide a rounded surface for the cord 83 to travel along. It will, however, be appreciated that the shape and/or configuration of the guide portion 94 is not necessarily limited by the shape and/or configuration as shown in the drawings and described above, and may be adapted to suit the design requirements of the storage cavity 82.

In FIG. 27, the cord 83 is shown to be in a retracted (storage) configuration, whereby the cord 83 is substantially contained within the storage cavity 82, whilst in FIG. 28, the cord 83 is shown in an extended (use) configuration, whereby the cord 83 is substantially external of the storage cavity 82.

While the invention has been described here as part of a coffee machine 10, and as discussed above, the extraction module 12 and the steam module 14 may each also be a stand-alone apparatus with its own drip tray assembly 18.

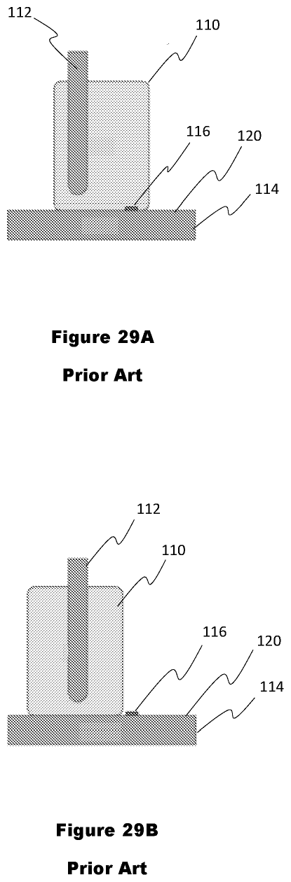

In FIGS. 29A to 40, there is schematically depicted a milk receptacle 100 supported on an apertured surface 120 of a drip tray 114, beneath a steam wand 112. The milk receptacle 100 is traditionally in the form of a metal milk jug which provides good thermal conductivity to the temperature sensor 116 in the apertured support surface 120 of the drip tray 114. The temperature sensor 116 may be provided in the form of a NTC thermistor (“Negative Temperature Coefficient” thermistor). The upper surface of the temperature sensor 116 is biased into engagement with the bottom of the metal milk jug 110 to generate an output indicative of the milk temperature as it is aerated by steam from the steam wand 112.

FIG. 29A shows the milk jug 110 correctly positioned beneath the steam wand 112 such that the temperature sensor 116 contacts the bottom of the jug. The end tip of the steam wand 112 is at the required spacing from the jug side walls, the bottom surface and the temperature sensor 116 for texturing of the milk in the manner specified by the device designers.

As shown in FIG. 29B, an incorrectly positioned the milk jug 110 will not properly engage the temperature sensor 116. Inaccurate or inconsistent outputs from the sensor has detrimental effects on the milk texturing process. While the milk jug 110 is still positioned beneath the steam wand 112 and the milk will be textured by the steam, the relative position of the jug 110 and steam wand 112 is not in accordance with the intended design. This detracts from the milk texturing and ultimately the flavor of the milk coffee. The texturing process is affected if the wand 112 is not correctly spaced from the side and/or the bottom of the jug 110. Spacing the wand 112 too close or too far from the bottom or sides of the jug 110 will change the flow pattern of the milk and hence the texturing process. Incorrect spacing between the temperature sensor 116 and the wand 112 may cause inaccurate temperature readings that do not correctly reflect the temperature of the milk. For example, the milk immediately adjacent the tip of the wand 112 may be significantly hotter than the averaged or ‘bulk’ temperature of the milk.

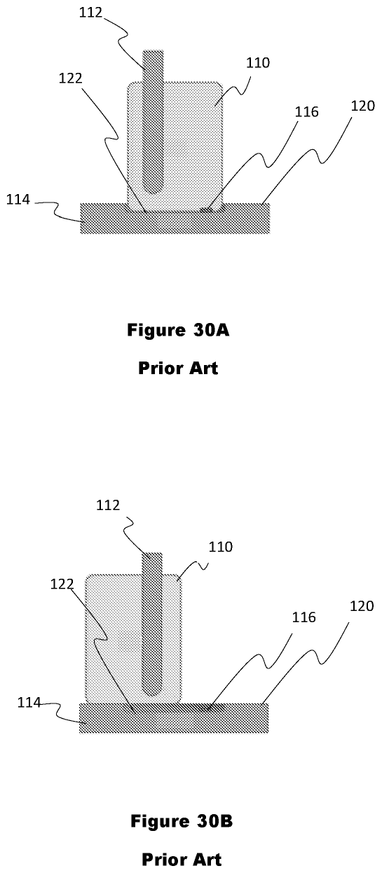

To influence and guide the user's placement of the milk jug 110 on the support surface 120, a shallow recess can provide a receptacle support 122 in the correct jug location. As shown in FIGS. 30A and 30B, the support surface 120 on top of the drip tray 114 has a shallow recess 122 beneath the steam wand 112. The temperature sensor 116 is positioned in the shallow recess 122 at the correct spacing from the steam wand 112. As shown in FIG. 30A, nesting the base of the milk jug 110 in the shallow recess 122 correctly locates the jug 110. However, if the user places the milk jug 110 on the support surface 120 such that it does nest into the recess 122 (see FIG. 30B) there is no contact between the jug and the temperature sensor 116. Similarly, the steam wand 112 may not be correctly spaced from the interior side wall or the bottom of the jug 110. Despite this, the milk texturing can still proceed despite the lack of temperature feedback and detrimental effects of an incorrectly positioned steam wand 112.

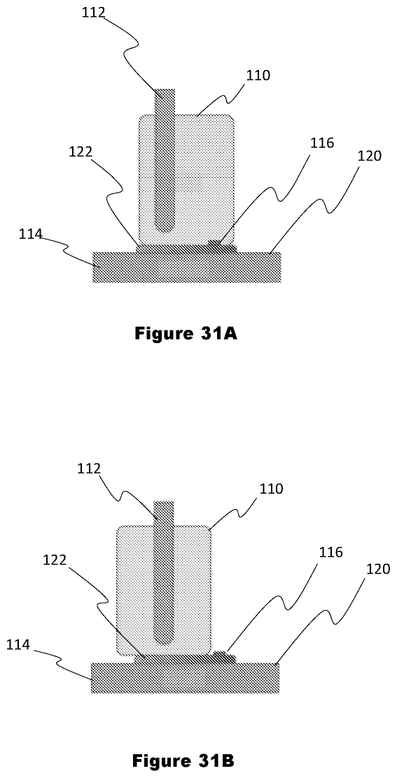

Referring to FIGS. 31A and 31B, the support surface 122 may also be in the form of a raised platform or plinth on the support surface 120 in the correct jug location. The temperature sensor 116 is incorporated into the raised support surface 122 for engaging the bottom of the jug 110 when correctly positioned as shown in FIG. 31A. However, if the jug 110 is incorrectly placed on the support surface 122 as shown in FIG. 31B, the temperature sensor 116 no longer contacts the milk jug 110. Likewise, the spacing from the tip of the steam wand 112 to the interior sides of the jug 110 will not be in accordance with design specifications. Misplacement of the jug 110 on the support surface 122 is relatively easy to see if the user makes a visual check. However, if the coffee is being prepared quickly, a user may not visually check but the milk frothing process will continue regardless, with the risk of detrimental effects to the resulting taste.

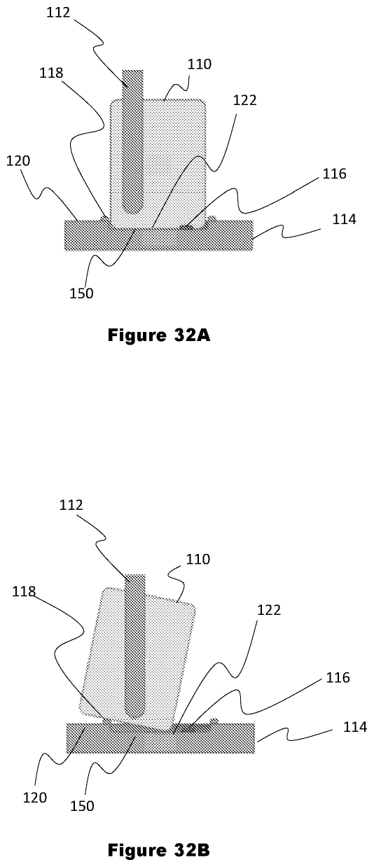

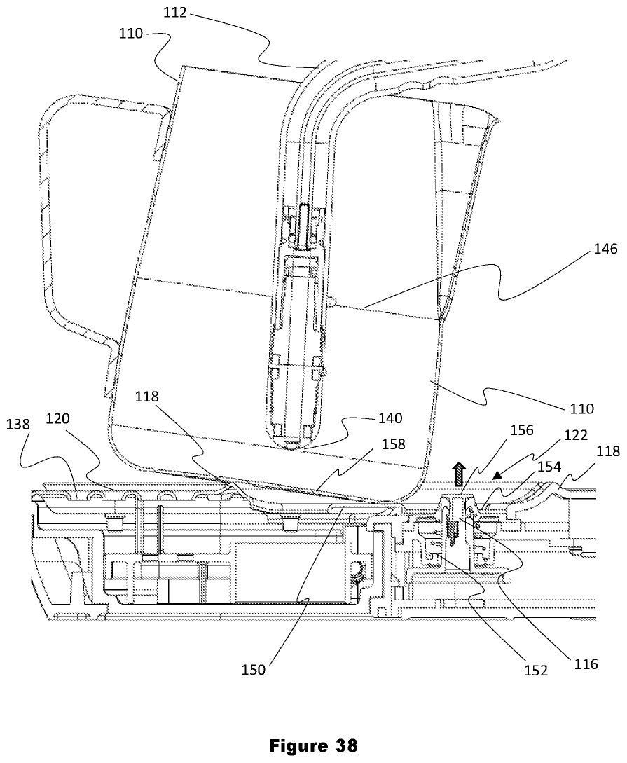

Referring to FIGS. 32A and 32B, the receptacle support 122 has a peripheral raised portion 118 extending above the support surface 120 on the drip tray 114 and a recessed portion 150 that is below the support surface 120. As shown in FIG. 32A, the correctly positioned milk jug 110 nests into the recessed portion 150 of the receptacle support 122 such that the temperature sensor 116 engages the bottom surface 158 (see FIG. 38) and the jug 110 sits stable and upright. On the other hand, if the jug 110 is incorrectly positioned as shown in FIG. 32B, a portion of the milk jug 110 rests on the raised peripheral portion 118 and the opposing side or portion of the milk jug 110 rests in the recessed portion 150. This height difference leaves the milk jug 110 sitting in a manner that is clearly askew and unstable. This provides a strong visual indicator to the user that the jug 110 has not been correctly positioned on the receptacle support 122 and prompts the corrective action.

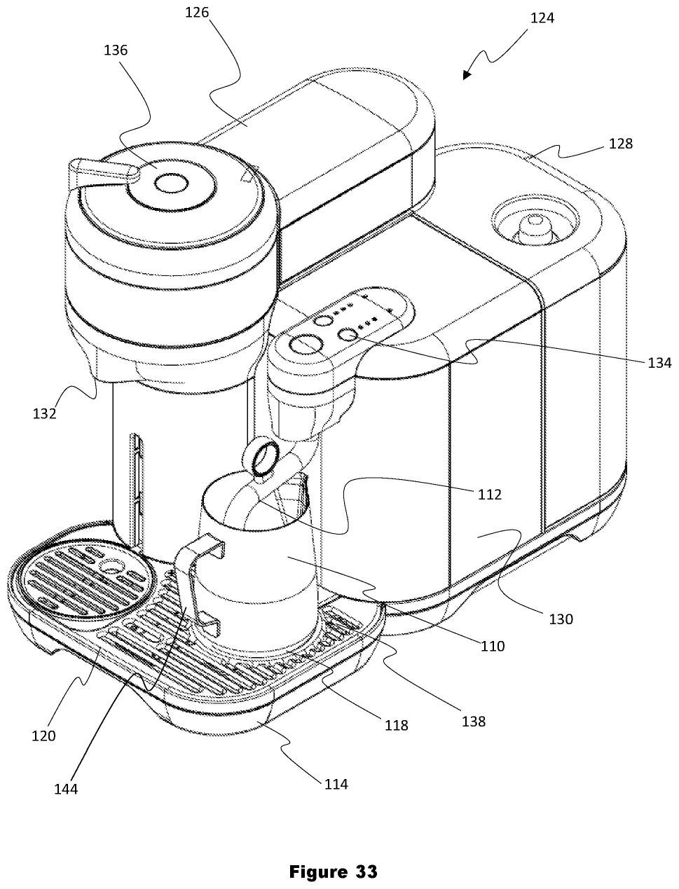

FIG. 33 shows a coffee machine 124 using the present invention to promote the correct positioning of a milk jug 110 on the drip tray 114. The three main components of the coffee machine 124 are the extraction device 126, the water tank 128 and milk texturing device 130. As discussed above, however, in other embodiments, the water tank 129 and the milk texturing device 130 may exist as a standalone device, separate from the extraction device 126. In the depicted embodiment, the extraction device 126 (sometimes referred to as the extraction module) receives coffee beans through the grinder lid 136 for grinding into a filter basket before infusion with 25ecognize25d hot water to dispense a dose of expresso coffee from the coffee spout 132. The coffee is collected in a cup or other receptacle sitting beneath the spout 132 on the apertured support surface 120 of the drip tray 114. The extraction module may also be of the capsule type in which a frangible pod of ground coffee is inserted through the lid 136 for infusion into the 25ecognize25d hot water.

Adjacent the extraction device 126 is the milk texturing device 130 (sometime referred to as the steam module) that draws water from the tank 128 to generate steam for injection into the milk via the steam wand 112. Again, as discussed above, the milk texturing device 130 or steam module may be provided separately to the extraction device 126 or extraction module. In the depicted embodiment, the steam wand 112 is rotatably connected at its upper end to rotate between a raised position where the milk jug 110 can be removed from the drip tray 114 using the jug handle 144, and a lowered position where the milk may be textured by the injection of steam through the wand 112. A user interface 134 is provided for operative control of the extraction and milk texturing processes. Encircling the base of the milk jug 110 is a peripheral raised portion 118 that extends upward from the apertured support surface 120 to provide a user indication of the correct jug location on the drip tray 114.

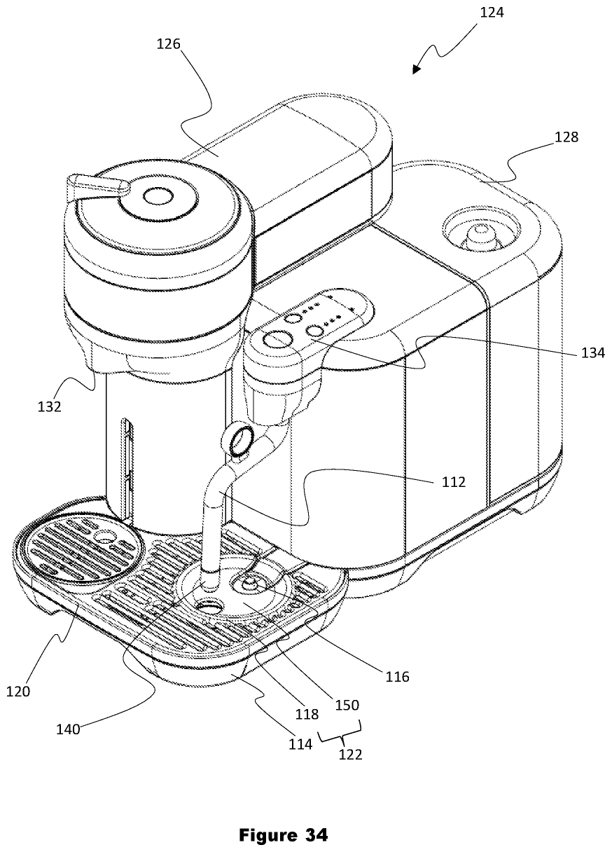

FIG. 34 shows the coffee machine 124 of FIG. 33 with the milk jug 110 removed to reveal the receptacle support 122. The receptacle support 122 of the present invention includes the raised peripheral portion 118 that is above the aperture support surface 120 while the recessed portion 150 is below the apertured support surface. A temperature sensor 116 in the form of an NTC Thermistor is positioned in the recessed portion 150 for contacting the bottom surface of the milk jug 110. The end tip 140 of the steam wand 112 (when in the lowered position) is towards the opposing side of the milk jug 110 so that the temperature sensor 116 provides a more accurate indication of the average milk temperature during the frothing process. In some embodiments, the temperature sensor is incorporated into the steam wand 112, and incorrect placement within the milk jug 110 alters the flow patterns (discussed below) which may also change the temperature sensed.

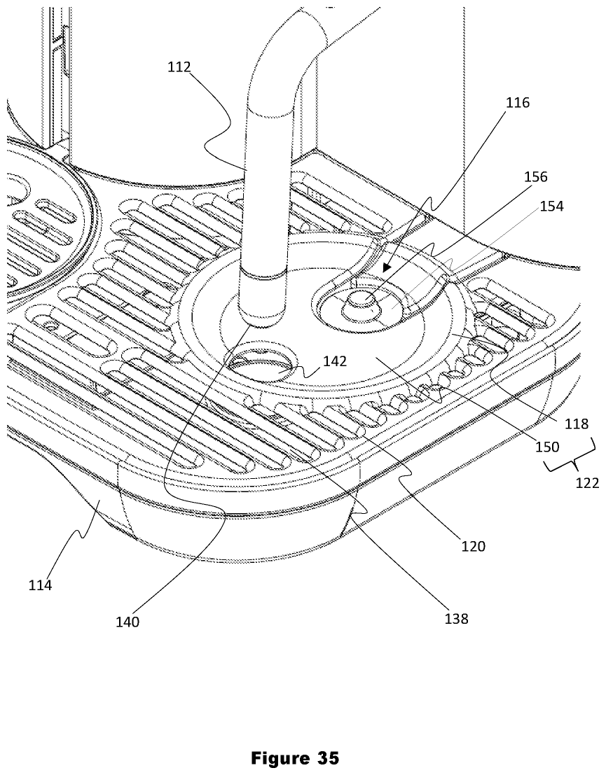

FIG. 35 is an enlarged perspective of the receptacle support 122 showing the peripheral raised portion 118 leading down to the recessed portion 150 via a sloped or curved intermediate surface that allows the milk jug 110 to abut the top of the temperature sensor 16. The raised peripheral portions 118 may be formed with any cross-sectional profile suitable for the base of the milk receptacle being used.

FIG. 35 also shows the steam jet opening 142 positioned directly beneath the end tip 140 of the steam wand 112 when in the lowered position. If the user chooses to vent steam from the wand 112 without a milk jug 110 in place, the ejected steam jet is directed through the opening 142 and diffuses within the drip tray 114 rather than divert outwardly from the recessed portion 150 and potentially scald the user. The support surface 120 also defines an array of apertures 138 substantially surrounding the raised peripheral forward portion 118 to allow any liquid spillages to drain into the drip tray 114.

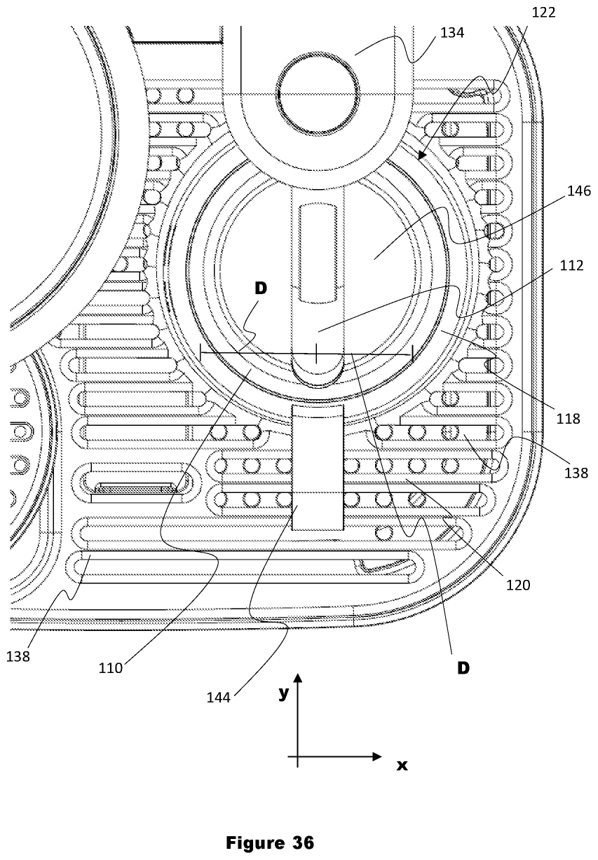

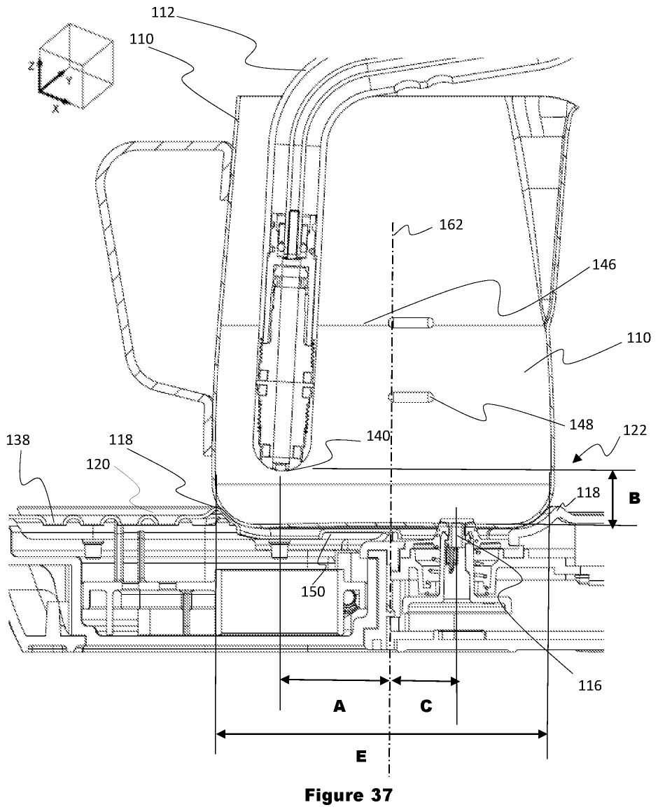

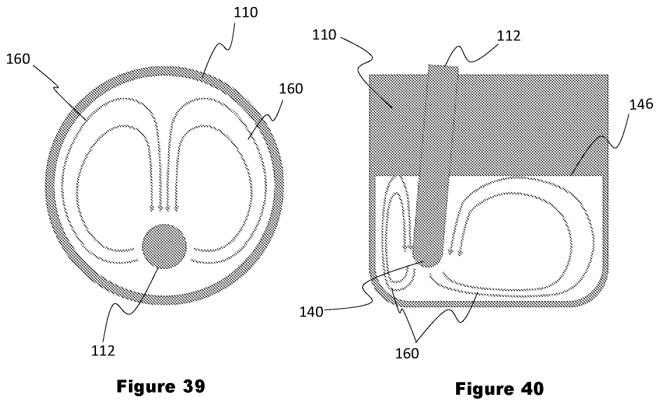

FIGS. 36 and 37 show the milk jug 110 correctly positioned on the apertured support surface 120 of the drip tray 114 such that the tip 140 of the steam wand 112 is correctly spaced from the sides and bottom of the jug 110. As best shown in FIG. 37, the steam wand 112 extends past the centre-line axis 162 of the milk jug 110 such that it is closer to the front (from the perspective of a user facing the machine) while the temperature sensor 116 is diametrically opposite towards the ‘back’ of the jug 110. The correct positioning of the steam wand 112 results in relatively predictable flow patterns 160 in the milk as schematically shown in FIGS. 39 and 40. The texturing of the milk is intended to occur with the predicted flow patterns 160 for a desired texture and taste in the resulting milk. The particular dimensions, and ratios of dimensions, that are influential in establishing the correct flow patterns 160 are:
The Y-axis position of the wand relative to the receptacle (see dimension A in FIG. 37)
The Z-axis position of the wand relative to the receptacle (see dimension B in FIG. 37)
The Y-axis position of the temperature sensor 16 to the receptacle (see dimension C in FIG. 37)
The X-axis position of the wand relative to the receptacle (see dimension D in FIG. 36)
The internal diameter of the milk receptacle (diameter E in FIG. 37)
The ratio of A:C.

When the milk jug 110 is correctly positioned, and the steam wand 112 is in the lowered position, the end tip 140 is to be fully submerged beneath the level of the milk 146, even if the milk level 146 is at the minimum-fill gradation 148. The operation of the milk texturing device 130 is configured for providing good texturing with the assumption that the tip 140 is at the correct spacings A, B, C and D. With the tip at the correct spacings, the jug 110 is stable and upright on the receptacle support 122.

In contrast, FIG. 38 shows the milk jug 110 incorrectly positioned on the receptacle support 122. In this position, the difference in elevation between the raised peripheral portion 118 and the recessed portion 150 tilts the jug 110 such that it is unstable and sitting askew. The user has immediate visual feedback of the problem and is prompted to adjust the jug 110 position.

With the jug 110 askew, the temperature sensor 116 does not engage the bottom surface 158. The temperature sensor 116 has a contact face 156 biased into contact with the bottom surface 158 with a biasing means such as a spring 152. The upward bias on the contact face 156 ensures a good thermal connection between the bottom surface 158 and the sensor 116 for more reliable and accurate temperature measurement of milk in the milk jug 110 (see FIG. 37).

The temperature sensor 116 has a flexible seal in the form of a diaphragm 154 between the sensor contact face 156 and the recessed portion 150 of the receptacle support 122. This protects electrical components within the sensor from liquid spills while allowing limited movement of the contact face 156 relative to the recessed portion 150 under the bias of the spring 52.

While the invention has been described here as part of a coffee machine 124, and as discussed above, the milk texturing device 130 may also be a stand-alone apparatus with its own drip tray 114. The aperture support surface would be dimensioned to accommodate the receptacle support 122 while still providing the array of drainage apertures 138 allowing spillage to collect in the drip tray 114.

The invention has been described herein by way of example only. Skilled workers in this field will readily recognize variations and modifications which do not depart from the spirit and scope of the broad inventive concept.

1. A coffee machine comprising:
a coffee extraction module with a dispensing spout and a supporting body;
a platform for detachable connection with the supporting body at a plurality of different spacings beneath the dispensing spout; and
a drip tray assembly positionable beneath the dispensing spout, the drip tray assembly having a support surface,
wherein the support surface of the drip tray assembly is configured to receive the platform such that the support surface and the platform are substantially co-planar, and
wherein the platform and the drip tray assembly are configured to engage and disengage from the supporting body via horizontal relative movement.

2. The coffee machine according to claim 1, wherein the support surface of the drip tray assembly is adapted to receive a receptacle, the support surface having apertures and a reservoir for collecting liquid draining through the apertures.

3. The coffee machine according to claim 2, wherein the platform is adapted to support the receptacle beneath the dispensing spout.

4. The coffee machine according to claim 3, wherein the platform is a movable cup support configured to detachably engage the drip tray assembly.

5. The coffee machine according to claim 4, wherein the supporting body of the coffee extraction module has a series of connection points for detachable inter-engagement with the cup support to provide the plurality of different spacings beneath the spout.

6. The coffee machine according to claim 5, wherein the connection points are sockets in the supporting body, wherein the cup support has a protrusion shaped for insertion in any of the sockets such that the platform is substantially horizontal.

7. The coffee machine according to claim 6, wherein the sockets include a lower socket disposed adjacent a lower surface of the supporting body, and wherein the protrusion of the cup support is horizontally slidable into the lower socket.

8. The coffee machine according to claim 1, further including a steam module for frothing milk, wherein the steam module has a steam wand and the drip tray assembly is positionable beneath the coffee dispensing spout and the steam wand.

9. The coffee machine according to claim 8, wherein the drip tray assembly has a coffee drip tray and a steam drip tray, and wherein the coffee drip tray and the steam drip tray are integrally formed.

10. The coffee machine according to claim 8, wherein the drip tray assembly has a coffee drip tray and a steam drip tray, the coffee drip tray being separately formed from the steam drip tray and movable relative to the steam drip tray.

11. The coffee machine according to claim 10, wherein the coffee drip tray has a coffee drip reservoir and the steam drip tray has a milk drip reservoir that is not fluidically connected to the coffee drip reservoir.

12. The coffee machine according to claim 10, wherein the coffee drip tray is detachably engageable with the platform such that the coffee drip tray and the platform are both positionable at the plurality of different spacings beneath the spout.
